(19) United States
(12) Patent Application Publication
(10) Pub. No.: US 2024/0225081 A1
(43) Pub. Date: Jul. 11, 2024

(54) FUME HARVESTING AND ACCUMULATION SYSTEM, METHOD AND EXTRACT FOR DISSOLVING IN A TINCTURE

(71) Applicant: 5G TOBACCO LABS LTD, JERUSALEM (IL)

(72) Inventor: Ilan FEFERBERG, Rishon Lezion (IL)

(21) Appl. No.: 18/289,004

(22) PCT Filed: May 17, 2022
(86) PCT No.: PCT/IL2022/050514

§ 371 Date: Oct. 31, 2023

(30) Foreign Application Priority Data
May 3, 2021 (IL) 282894

(51) Int. Cl. A24B 15/24; A24B 15/167; B01F 23/213; B01F 25/433; B01F 31/80

(52) U.S. Cl. CPC A24B 15/241; A24B 15/167; B01F 23/2132; B01F 25/4338; B01F 31/84; B01F 2215/0454

(57) ABSTRACT

Fume extract extracted by a fume-dissolution harvesting and accumulation system for accumulating in a tincture featuring at least one sonic cavitation device configured to exert cavitation effect in a solvent-fume mix, and a fume generating compartment for burning and/or vaporizing fume-releasing source-material configured to produce a portion of the fume at burning temperatures, and another portion at evaporation temperatures. Corresponding method is provided.

### FIELD OF THE DISCLOSED TECHNIQUE

The present invention relates to devices, systems and methods for accumulating fume, vapor, smoke, and the like in a tincture. More particularly, the present invention relates to a device, system and method for harvesting fume by stimulating and enhancing dissolution of fume in a solvent for preparing a tincture and similar preparations.

### SUMMARY OF THE DISCLOSED TECHNIQUE

In accordance with the disclosed technique there is thus provided a fume-extract including a dissolved-fume-extract accumulated in a solvent (“tincture”) by a fume-dissolution harvesting and accumulation system for accumulating fume in the solvent, or a fume-extract-concentrate distilled from the dissolved-fume-extract. The system includes a fume-dissolution harvester for dissolving and harvesting fume in a liquid solvent having at least one sonic cavitation device configured to exert cavitation effect in a mixture of liquid-solvent and fume (“solvent-fume mix”) wherein the fume includes gas, smoke, vapor, mist, and/or fume-particles suspended in the gas. The solvent may be ethanol, acetonitrile, propylene glycol, glycerol, water, methanol, organic solvent, and/or any combination of any of the above. The system further includes a fume generating compartment for burning and/or vaporizing fume-releasing source-material (matter) for producing said fume which is provided to the at least one fume-dissolution harvester, wherein the fume generating compartment is configured to produce a portion of the fume by exposure of the fume-releasing source material to combustion at burning temperatures, and another portion of the fume by exposure of the material to evaporation temperatures.

The sonic cavitation device may feature a convergent-divergent neck for exerting cavitation in the solvent-fume mix when streamed through the neck, which is a subsonic cavitation device, such as a venturi.

for a smooth or a choked flow, or a supersonic cavitation device, such as a de Laval nozzle operational for exerting a supersonic shockwave, which exerts high dispersion forces on the liquid at or downstream of the shockwave (e.g., having an over expanded nozzle configured to induce a free shock separation by satisfying Summerfield Criterion of P=0.4 . . . 0.35 Pa), and may be further operational for vacuum pumping of the fume. The at least one sonic cavitation device may include at least two sonic cavitation devices consecutively arranged in series along a streamline, such as a subsonic cavitation device and a supersonic cavitation device disposed downstream thereof, or to exert subsonic cavitation or supersonic cavitation in a single sonic cavitation device whose convergent-divergent neck is operative to exert cavitation effect and a supersonic shockwave.

The at least one sonic cavitation device may include an ultrasonic transmitter for transmitting ultrasound energy into the solvent-fume mix, wherein the ultrasonic transmitter may be configured to operate at frequency range of 0.7-5 MHz, and at intensity range of 0.3-50 Watt/Cm². The ultrasonic transmitter is disposed at a pool of the solvent and wherein the solvent-fume mix is released at the bottom of the pool to produce gaseous bubbles which rise through the pool while being exposed to ultrasound energy of the ultrasonic transmitter, and a series of horizontal perforated plates may be disposed in the pool for slowing down the rising of the gaseous bubbles in the pool, for prolonging exposure of the bubbles to the ultrasound energy, wherein the solvent-fume mix gushes out from another of the at least one sonic cavitation device. The at least one sonic cavitation device can include a convergent-divergent neck for exerting cavitation in the solvent-fume mix when streamed through the neck, wherein at least one ultrasonic transmitter is mounted at, or downstream in the vicinity of, or downstream away from, the neck or the vena contracta of the neck.

The convergent-divergent neck may be formed by an hourglass shaped tube, constricted in an intermediate section between an upstream inlet lobe into which the solvent-fume mix is streamed from a source of fume at an inlet-pressure and a jet of fog-sized liquid solvent droplets is sprayed via a spout nozzle, and a downstream outlet lobe in which an outlet-pressure is lower than the inlet-pressure to define a pressure difference between the inlet lobe and the outlet lobe, wherein the upstream inlet lobe tapers at an entry cone gradience toward the neck and the downstream outlet lobe tapers at an exit cone gradience toward the neck, to thereby induce cavitation effect and/or shockwave at the downstream outlet lobe. The constricted intermediate section may be asymmetrical wherein the entry cone gradience is different (e.g., greater—for facilitating the inducing of shockwave at said downstream exit lobe) from the exit cone gradience, and feature a venturi tube, wherein the entry cone gradience is 30 degrees or steep in the range of 5 to 40 degrees and the exit cone gradience is 5 degrees or is moderate in the range of 3 to 20 degrees, or feature a de Laval nozzle, wherein the exit cone gradience is greater than the entry cone, e.g., steep in the range of 5 to 40 degrees while the entry cone gradience is moderate in the range of 3 to 20 degrees (for facilitating the inducing of shockwave at the downstream exit lobe). The downstream inlet lobe may include an L-shaped chamber connected downstream to the constricted intermediate section and having an upstream fume inlet from which a flow stream of the fume is streamed, wherein the liquid solvent spray is sprayed via a spout at an interim location facing the constricted intermediate section for sweepingly drifting the spray by the flow stream.

In accordance with further aspects of the invention, there is provided a fume-dissolution harvesting and accumulation system for accumulating fume in a solvent, including at least one fume-dissolution harvester for harvesting fume by dissolution in a liquid solvent and a fume generating compartment for burning and/or vaporizing matter for producing the fume provided to the at least one fume-dissolution harvester, wherein the fume generating compartment includes an intermittent fume-generation inducer for inducing intermittent burning or heating of the matter to avoid pyrolysis. The fume generating compartment may include an optional aerator for oxygenating combustion. The intermittent fume-generation inducer may include an air pump (which can feature the aerator), a balloon vaporizer, and/or a valve, for inducing, conducting, or allowing intermittent flow of gas into or from the fume generating compartment, or a controller operational to control the intermittent burning or heating. The intermittent fume-generation inducer may be operational to repeat the intermittent heating at the intrinsic temperature of at least one specific compound or at successively/progressively rising intrinsic temperatures of respective ones of said at least one specific compounds for separately vaporizing said at least one specific compound to allow their respective separate collection.

Some embodiments of the invention disclose a fume-dissolution harvesting and accumulation system for accumulating fume in a solvent, which included at least one fume-dissolution harvester for harvesting fume by dissolution in a liquid solvent, and a closed loop gas circulation (e.g., including piping and a recirculation blower) for recirculating under pressure gas-fume mix remainder separated from the liquid solvent downstream of a receptacle for accumulating the fume as a solute dissolved in the solvent, into the at least one fume dissolution harvester, a preliminary fume and solvent mixing chamber disposed upstream of the at least one fume dissolution harvester, and/or a fume generating compartment.

Some embodiments of the invention disclose a fume-dissolution harvesting and accumulation system for accumulating fume which includes the at least one fume-dissolution harvester for harvesting fume by dissolution in a liquid solvent, and at least one of: a fume generating compartment for burning and/or vaporizing matter for producing the fume provided to the at least one fume-dissolution harvester; vaporization, combustion, and/or heating means for inducing the burning and/or vaporizing in the fume generating compartment; an aerator for oxygenating combustion in the fume generating compartment; a fume conveying conduit for conveying fresh fume from the fume generating compartment into the at least one fume dissolution harvester; a fume blower for drawing fume through the conveying conduit; a preliminary mixing chamber for enhancing dissolution of fume in liquid solvent before entering the at least one fume dissolution harvester; a tincture receptacle featuring a tincture pool, for engorging fume particles dissolved in liquid solvent and harvested by the at least one fume dissolution harvester; a solvent reservoir for supplying solvent to the liquid solvent pool, the at least one fume accumulator, and/or for conduit residue collection and cleansing; piping for conducting the fume-solvent mix from the fume at least one dissolution harvester to the tincture receptacle; a solvent-fume cooler for cooling heated solvent-fume mix downstream of the at least one fume dissolution harvester before streaming into the tincture receptacle; an ultrasound transmitter for transmitting ultrasound energy into the solvent-fume mix along piping of the system; a turbulence unit for enhancing dissolution featuring a Tesla valve disposed right before streaming into the tincture receptacle for passing the solvent-fume mix in the resisting direction thereof for slowing the stream and creating vortices and turbulent flow, to thereby exert pressure on the bubbles; an ultrasonic transmitter disposed in a pool of said solvent and wherein said solvent-fume mix is released at the bottom of said pool to produce gaseous bubbles which rise through the pool while being exposed to ultrasound energy of said ultrasonic transmitter; a series of horizontal perforated plates disposed in said pool and operational for slowing down the rising of said gaseous bubbles in said pool, for prolonging exposure of said bubbles to said ultrasound energy, wherein said solvent-fume mix gushes out from another of said at least one sonic cavitation device; a receptacle precipitation separator for separating gas and fume from liquid solvent upon reaching the receptacle from the at least one fume dissolution harvester or upon emitting from the solvent pool; a cyclone separator for separating cooled gas-fume mix from liquid solvent, downstream of the fume receptacle; a solvent condenser for condensing solvent remainder after cyclone separation downstream of the cyclone separator; eaves for conducting liquidized matter (solvent and solute) to the pool, from the receptacle precipitation separator, the cyclone separator, and/or the condenser; solvent circulation for feeding liquid solvent or tincture from the pool or a solvent reservoir to the at least one fume dissolution harvester or the preliminary mixing chamber, including piping and a solvent drawer; an internal conduit residue collection cleansing mechanism operative for washing piping and conduits of the fume dissolution harvester system with the liquid solvent for releasing fume residue adhered to the sides of the conduits, and for circulating the liquid solvent with the released fume through the conduits to the pool; an intermittent fume-generation inducer for inducing intermittent burning or heating of the matter in the fume generating compartment to avoid pyrolysis; at least one of: an air pump/aerator; a balloon vaporizer; and a valve of the intermittent fume-generation inducer for inducing, conducting, or allowing intermittent flow of gas into or from the fume generating compartment; a controller of the intermittent fume-generation inducer operational to control the intermittent burning or heating; the intermittent fume-generation inducer configured to repeat the intermittent heating at the intrinsic temperature of at least one specific compound or at successively/progressively rising intrinsic temperatures of respective ones of the at least one specific compounds for separately vaporizing the at least one specific compound to allow their respective separate collection; a closed loop gas circulation including piping and a recirculation blower for recirculating under pressure gas-fume mix remainder separated from the liquid solvent downstream of the receptacle into at least one of: the at least one fume dissolution harvester, the preliminary fume and solvent mixing chamber disposed upstream of the at least one fume dissolution harvester, and the fume generating compartment; a solvent remover for distilling said fume-extract-concentrate by removal of said solvent from said dissolved-fume-extract, which may feature an evaporator such as a pressure reducing-, a rotary-evaporator, and a centrifugal-evaporator, and a controller for controlling operation of system components, and setting and controlling system parameters, such as time duration of operation, total weight of matter to be processed solvent weight before and after the process, pre-set temperature at a fume generator compartment, pressure of liquids, air/gas pressure, vacuum pressure, weight of ash, the degree of turbidity of the solvent for indicating the absorption level of the fume, optical means for qualitative or quantitative measurement of dissolved components, and at least one temperature sensor for monitoring and controlling evaporation or combustion heat.

In accordance with further aspects of the invention, there is provided a fume-extract including a dissolved-fume-extract accumulated in a solvent (“tincture”) by a fume-dissolution harvesting and accumulation method for accumulating fume in the solvent, or a fume-extract-concentrate distilled from said dissolved-fume-extract. The method includes the procedure of generating fume in a generating compartment by burning and/or vaporizing fume-releasing source material, wherein said fume comprises gas, and smoke, vapor, mist or fume-particles suspended in said gas, wherein said generating comprises generating a portion of said fume by exposure of said fume-releasing source material to combustion at burning temperatures, and another portion of said fume by exposure of said fume-releasing source material to evaporation temperatures The method further includes the procedure of harvesting the fume by at least one fume dissolution harvester operational for dissolving the fume as a solute in a liquid solvent, by exerting cavitation in a mixture of liquid-solvent and the fume (“solvent-fume mix”) by subjecting the solvent fume mix to the cavitation effect of at least one sonic cavitation device. Exerting cavitation may include streaming the solvent-fume mix through a convergent-divergent neck of the at least one sonic cavitation device, exerting subsonic cavitation wherein the at least one sonic cavitation device includes a subsonic cavitation device, and/or exerting supersonic shockwave in the solvent-fume mix wherein the at least one sonic cavitation device includes a supersonic cavitation device. The method may further include vacuum pumping of the fume by the at least one sonic cavitation device, which may feature a venturi. The streaming may include a smooth or a choke flow through a venturi tube. The supersonic cavitation device may include a de Laval nozzle, and the exerting of supersonic shockwave may include inducing free shock separation by satisfying Summerfield Criterion of P=0.4 . . . 0.35 Pₐ in an over expanded tube-neck of the de Laval nozzle.

Exerting cavitation can include subjecting of the solvent-fume mix to at least two sonic cavitation devices consecutively arranged in series along a streamline, and such as by subjecting to a subsonic cavitation in an upstream subsonic cavitation device and to a supersonic shockwave in a downstream supersonic cavitation device. Exerting cavitation may include exerting a subsonic or supersonic cavitation and a supersonic shockwave in a single sonic cavitation device whose convergent-divergent neck is operative to exert cavitation effect and a supersonic shockwave.

Exerting cavitation may include exerting ultrasonic cavitation by transmitting ultrasound energy into the solvent-fume mix by an ultrasonic transmitter of the at least one sonic cavitation device, such as by applying ultrasonic energy at frequency range of 0.7-5 MHZ, and at intensity range of 0.3-20 Watt/Cm². Exerting cavitation may include streaming the solvent-fume mix through a convergent-divergent neck of the at least one sonic cavitation device, and wherein exerting ultrasonic cavitation is performed in addition to the streaming by the ultrasonic transmitter which is mounted and operating at, or downstream in the vicinity of, or downstream away from, the neck or the vena contracta of the neck. Exerting ultrasonic cavitation may include releasing the solvent-fume mix at the bottom of a solvent pool to produce gaseous bubbles which rise through the pool and transmitting ultrasound energy by the ultrasonic transmitter disposed in the pool to the of the gaseous bubbles. The releasing may include slowing down the rising of the gaseous bubbles in the pool by a series of horizontal perforated plates disposed in the pool and operational for prolonging exposure of the bubbles to the ultrasound energy, wherein the solvent-fume mix gushes out from another of the at least one sonic cavitation device.

According to further aspects of the invention there is provided a method for fume harvesting and accumulation, including generating fume in a generating compartment by burning and/or vaporizing matter, wherein the fume includes gas, and smoke, vapor, mist or fume-particles suspended in the gas, wherein the generating includes inducing intermittent burning or heating of the matter to avoid pyrolysis by an intermittent fume-generation inducer, and harvesting the fume by at least one fume dissolution harvester operational for dissolving the fume as a solute in a liquid solvent. Inducing intermittent burning or heating may include inducing, conducting, or allowing intermittent flow of gas into or from the fume generating compartment by an air pump or an aerator, a balloon vaporizer, and/or a valve, or controlling of the intermittent burning or heating by a controller. Inducing intermittent burning or heating may include repeating the intermittent heating at the intrinsic temperature of at least one specific compound or at successively/progressively rising intrinsic temperatures of respective ones of the at least one specific compound for separately vaporizing the at least one specific compound to allow their respective separate collection.

According to further aspects of the invention there is provided a method for fume harvesting and accumulation, including harvesting fume by at least one fume dissolution harvester operational for dissolving the fume as a solute in a liquid solvent, wherein the fume includes gas and smoke, vapor, mist or fume-particles suspended in the gas, and recirculating gas-fume mix under pressure in a closed loop gas circulation, wherein the gas-fume mix is the remainder separated from the liquid solvent downstream of a receptacle for accumulating the fume as a solute dissolved in the solvent, wherein the circulation includes piping and a recirculation blower operational for recirculating the gas-fume mix into at least one of: (1) the at least one fume dissolution harvester; (2) a preliminary fume and solvent mixing chamber disposed upstream of the at least one fume dissolution harvester, and (3) a fume generating compartment.

In some embodiments of the disclosed invention the method for fume harvesting and accumulation includes generating fume in a generating compartment by burning and/or vaporizing matter, providing the generated fume to the at least one fume dissolution harvester, harvesting the fume by at least one fume dissolution harvester by dissolution in a liquid solvent, including the procedure of exerting cavitation in a solvent-fume mix by subjecting the solvent fume mix to the cavitation effect of at least one sonic cavitation device, and any of the following: generating includes inducing burning and/or vaporizing matter with vaporization, combustion, and/or heating means; generating includes oxygenating combustion by aerating with an aerator; providing the generated fume including conveying fresh fume from the fume generating compartment via a fume conveying conduit into the at least one fume dissolution harvester; conveying fresh fume includes drawing fume by a fume blower through the fume conveying conduit; enhancing dissolution of fume in liquid solvent by mixing the fume and the liquid solvent in a preliminary mixing chamber into a solvent-fume mix before entering the at least one fume dissolution harvester; engorging fume particles dissolved in liquid solvent and harvested by the at least one fume dissolution harvester, in a tincture receptacle featuring a tincture pool; supplying solvent from a solvent reservoir to at least one of: (1) the liquid solvent pool; (2) the at least one fume accumulator, and (3) for conduit residue collection and cleansing; conducting the fume-solvent mix from the at least one fume dissolution harvester to the tincture receptacle by piping; cooling heated solvent-fume mix by a solvent-fume cooler disposed downstream of the at least one fume dissolution harvester before streaming into the tincture receptacle; transmitting, by an ultrasound transmitter, ultrasound energy into the solvent-fume mix along piping of the system; enhancing dissolution by passing the solvent-fume mix in the resisting direction of a turbulence unit featuring a Tesla valve right before streaming into the tincture receptacle, configured for slowing the stream and for creating vortices and turbulent flow, which thereby exert pressure on the bubbles for enhancing dissolution; releasing said solvent-fume mix at the bottom of a solvent pool to produce gaseous bubbles which rise through said pool and transmitting ultrasound energy by an ultrasonic transmitter disposed in said pool to said of said gaseous bubbles; slowing down the rising of said gaseous bubbles in said pool by a series of horizontal perforated plates disposed in said pool and operational for prolonging exposure of said bubbles to said ultrasound energy, wherein said solvent-fume mix gushes out from another of said at least one sonic cavitation device; separating gas and fume from liquid solvent by a receptacle precipitation separator, upon reaching the receptacle from the at least one fume dissolution harvester, or upon emitting from the solvent pool; for separating cooled gas-fume mix from liquid solvent by a cyclone separator disposed downstream of the fume receptacle; condensing solvent remainder after cyclone separation by a solvent condenser disposed downstream of the cyclone separator; conducting liquidized matter (solvent and solute) to the pool, by eaves conveying liquids for from the receptacle precipitation separator, the cyclone separator, and/or the condenser; solvent circulation for feeding liquid solvent or tincture from the pool or a solvent reservoir to the at least one fume dissolution harvester or the preliminary mixing chamber, including piping and a solvent drawer; washing piping and conduits of the fume dissolution harvester system with the liquid solvent, by an internal conduit residue collection cleansing mechanism operative for releasing fume residue adhered to the sides of the conduits, and for circulating the liquid solvent with the released fume through the conduits to the pool; inducing intermittent burning or heating of the matter to avoid pyrolysis by an intermittent fume-generation inducer; the inducing intermittent burning or heating including inducing, conducting, or allowing intermittent flow of gas into or from the fume generating compartment by an air pump or an aerator, a balloon vaporizer, and/or a valve; the inducing intermittent burning or heating including controlling the intermittent burning or heating by a controller; the inducing intermittent burning or heating including repeating the intermittent heating at the intrinsic temperature of at least one specific compound or at successively/progressively rising intrinsic temperatures of respective ones of the at least one specific compound for separately vaporizing the at least one specific compound to allow their respective separate collection; recirculating gas-fume mix under pressure in a closed loop gas circulation, wherein the gas-fume mix is the remainder separated from the liquid solvent downstream of a receptacle for accumulating the fume as a solute dissolved in the solvent, wherein the circulation includes piping and a recirculation blower operational for recirculating the gas-fume mix into the at least one fume dissolution harvester, a preliminary fume and solvent mixing chamber disposed upstream of the at least one fume dissolution harvester, and/or a fume generating compartment; distilling a fume-extract-concentrate by removing the solvent from the dissolved-fume-extract, which may include evaporating by a pressure reducing-, a rotary-, or a centrifugal-evaporator; and controlling, by a controller, operation of system components, and setting and controlling system parameters, including time duration of operation, total weight of matter to be processed, solvent weight before and after the process, pre-set temperature at a fume generator compartment, pressure of liquids, air/gas pressure, vacuum pressure, weight of ash, the degree of turbidity of the solvent for indicating the absorption level of the fume, optical means for qualitative or quantitative measurement of dissolved components, and/or at least one temperature sensor for monitoring and controlling evaporation or combustion heat.

In accordance with some aspects of the invention, fume-extract or tincture harvested according to the invention can be used as an ingredient of: (1) a tincture for consumption comprising the dissolved-fume-extract; (2) a tincture for consumption in which said fume-extract-concentrate is blended; (3) consuming material; (4) material for medical purposes; (5) material for cosmetic purposes; (6) material recreational purposes; (7) user-experience additive; (8) fragrance; (9) flavouring; (10) aroma; (11) vaping material; (12) inhaling material; (13) smoking material; (14) drinking material; (15) eating material; (16) e-liquid of electronic cigarettes (e-cigarettes); and (17) material for topical application. A portion of the fume may be harvested by exposure of the fume releasing source material to combustion at burning temperatures, and another portion of the fume is harvested by exposure of the material to evaporation temperatures. The source-material may be a smoking matter, tobacco, and/or cannabis. For consumption in an e-liquid by an e-cigarette, preferably up to 30% of the fume-extract-concentrate may be harvested by exposure of the fume releasing source material to combustion at burning temperatures, wherein the remainder is harvested by exposure of the material to evaporation temperatures. The e-cigarette may be a device combining smoking-material/tobacco/cannabis heating system, such as a combusted or non-combusted heat-stick.

The fume/tincture manufactured according to the invention can contain particularly low levels of Harmful and Potentially Harmful Constituents (HPHCs) found in combusted cigarettes, HPHCs found in smoke and vapor of tobacco or cannabis heating systems, carcinogenic chemicals, genotoxic chemicals, and/or cytotoxic chemicals. The low levels may be below 10% of those found in combusted cigarettes or in smoke and vapor of tobacco or cannabis heating systems.

### BRIEF DESCRIPTION OF THE DRAWINGS

The disclosed technique will be understood and appreciated more fully from the following detailed description taken in conjunction with the drawings in which:

FIG. 1 depicts an embodiment constructed and operative in accordance with the invention featuring a combined sonic fume-dissolution harvester for stimulating and enhancing fume dissolution in a solvent by sub-, super-, and ultra-sonic constrains;

FIG. 2 depicts another embodiment constructed and operative in accordance with the invention featuring a sonic fume-dissolution harvester for stimulating and enhancing fume dissolution in a solvent by separate subsonic and supersonic constrictions, each combined with an ultrasonic constrain;

In FIG. 3 depicts another embodiment constructed and operative in accordance with the invention featuring a sonic fume-dissolution harvester for stimulating and enhancing fume dissolution in a solvent by a subsonic/supersonic constriction, and separate ultrasonic constrains;

FIGS. 4A to 4E are sequential enlarged partial views of sections of the embodiment of FIG. 3. FIG. 4A is an enlarged view of a subsonic cavitation device of the sonic fume-dissolution device of FIG. 3;

FIG. 4B is an enlarged view of the section extending from a subsonic cavitation device to an ultrasonic transmitter of the sonic fume-dissolution harvester of FIG. 3;

FIG. 4C is an enlarged view of the section extending from an ultrasonic transmitter to a subsonic/supersonic cavitation device of the sonic fume-dissolution harvester of FIG. 3;

FIG. 4D is an enlarged view of subsonic/supersonic cavitation device 303 of sonic fume-dissolution harvester of FIG. 3; and

FIG. 4E is an enlarged view of the section extending from a subsonic/supersonic cavitation device to an ultrasonic transmitter of sonic fume-dissolution harvester of FIG. 3;

FIG. 5 illustrates a fume dissolution and accumulation system denoted 400 constructed and operative in accordance with the invention, which includes a sonic fume-dissolution harvester according to FIG. 1, 2, or 3;

FIGS. 6A-6F are schematic charts of several heating patterns as a function of time, of a matter heated in conjunction with the system of FIG. 5;

FIGS. 7-10B illustrate variations of a fume dissolution and accumulation system constructed and operative in accordance with the invention which includes a sonic fume-dissolution harvester according to FIG. 1, 2 or 3. FIG. 7, illustrates a closed-loop system constructed and operative in accordance with the invention featuring ultrasound transmitters disposed in a solvent pool;

FIG. 8 illustrates a closed-loop system constructed and operative in accordance with the invention featuring a heating chamber in which the matter to be vaporized is placed, while a separate stove heats recirculated dry gas; In FIG. 9, there is shown a closed-loop system constructed and operative in accordance with the invention in which burning is taking place in an oven with oxygen enrichment;

In FIG. 10A, there is shown a closed-loop system constructed and operative in accordance with the invention, employing a balloon vaporizer;

In FIG. 10B, there is shown a closed-loop system constructed and operative in accordance with the invention, employing a hookah vaporizer;

FIG. 11 is a block diagram of fume dissolution method operative in accordance with the invention for stimulating and enhancing fume dissolution in a solvent by sub-, super-, and ultra-sonic constrains;

FIG. 12 is a block diagram of a fume dissolution and accumulation method operative in accordance with the invention for stimulating and enhancing fume dissolution in a solvent by sub-, super-, and ultra-sonic constrains;

FIG. 13 is a block diagram of yet another fume dissolution and accumulation method operative in accordance with the invention for stimulating and enhancing fume dissolution in a solvent by sub-, super-, and ultra-sonic constrains;

FIGS. 14A and 14B feature a block diagram of a further fume dissolution and accumulation method operative in accordance with the invention for stimulating and enhancing fume dissolution in a solvent by sub-, super-, and ultra-sonic constrains; and

FIG. 15, is a table presenting HPHC estimated yields from ‘invention-tincture aerosols’ in comparison to conventional heat-stick aerosols and combusted cigarettes.

### DETAILED DESCRIPTION OF THE EMBODIMENTS

It is an object of the present invention to provide devices, systems and methods for effectively harvesting fume, vapor, smoke, mist, or gas (all of which are collectively referenced herein for convenience as “fume”) in a liquid, often referred to as a solvent, to create tinctures and similar preparations, whether for medical or recreational uses, or as a means to harvest, accumulate and/or collect the fume in a solid form which is adequate for further processing or other chemical purposes (e.g., preparation of tablets, capsules and other packing forms for direct consumption or as a crude source for extraction of materials, inclusion in another compound, and the like). A solvent may be selected with a boiling temperature which is lower than that of the dissolved fume, allowing easy evaporation of the volatile solvent, leaving a fume residue (liquid or solid). It is another object of the present invention to provide a device, system and method for accumulating fume while keeping the piping and conduits of such systems relatively free of residue, for reducing their cleansing requirements.

In chemistry, a tincture is a solution that has ethanol as its solvent. In herbal medicine, alcoholic tinctures are made with various ethanol concentrations. Other solvents for producing tinctures include vinegar, glycerol or glycerin (in glyceride), diethyl ether and propylene glycol, low volatility substances such as iodine and mercurochrome, water, and a combination of ethyl alcohol and water as solvents.

Accordingly, the term “tincture” herein refers to any preparation of liquid in which fume—or any derivative thereof, is accumulated, including but not limited to lotions, solutions, suspensions, emulsions, liquid mixtures, e-liquid (for electronic cigarettes), and any like preparations or ‘tinctures’. For clarification, the tincture in which the accumulated fume is dissolved, is also named herein “dissolved-fume extract”, and after removal of the solvent therefrom, the distilled remained is also named herein “fume-extract-concentrate”. Both the “dissolved-fume extract” and the “fume-extract-concentrate” are forms of the “fume extract” which is the product of the present invention. When the “fume extract” constitutes or is blended in a “tincture” in the daily connotation of this term, namely—tincture which is prepared for consumption (e.g., medical, cosmetic, vaping, or edible tincture), the term used herein therefor is “a tincture for consumption” or “a tincture for consuming”. Under this terminology, it is an object of the invention to provide fume-extract which includes a dissolved-fume-extract accumulated in a solvent by a fume-dissolution harvesting and accumulation system and/or method for accumulating fume in the solvent, or a fume-extract-concentrate distilled from the dissolved-fume-extract.

Tinctures and like preparations are prepared from cold extraction of herbal or organic substances such as tobacco, hemp (for extracting CBDA and THCA), olive, and sage for medical, cosmetic, and/or recreational purposes by cold processes such as cold press, dipping in alcohol, co₂ or butane, or hot processes such as evaporation, and/or burning (smoking)—which are the only processes in which certain bioactive compounds can be created or extracted.

For example, THCA (Tetrahydrocannabinolic acid) is a natural ingredient of hemp plant (cannabis) which is inactive and has no psychoactive effects in its natural form and the consumption of natural hemp plant (by eating) has no such effect. However, when THCA is heated to a temperature above 125 degrees centigrade (by smoking, evaporation, or cooking) it undergoes decarboxylation which separates carbon atoms from the molecular chain of the acid and thereby transforms into THC (tetrahydrocannabinol) which is bioactive and has psychoactive effects (Accordingly, THCA is a precursor of THC). Similarly, bioactive ingredients, including aromatic compounds, of tobacco and other herbal substances appear by smoking and evaporation—which release a profile of substances which is deem “ideal” (because its effect is proven) from the molecular spectrum of releasable substances. To retrieve the medical or personal desired effects or a smoked plant, it is imperative to extract the bioactive ingredients having a profile (i.e., typical ingredients at typical ratios) which is similar to that of the “ideal” profile which is received by conventional smoking of the plant.

For example, tobacco or hemp burns at the edge of a cigarette at temperatures reaching about 700 degrees centigrade, while the temperature of cigarette portion between the lips of the smoker is only 30 degrees centigrade. Different bioactive ingredients of tobacco and hemp appear at different temperatures in between 30 degrees and 700 degrees. An exemplary non limiting list of known precursor substances (cannabinoids for hemp), which release bioactive substances (some of which have desirable effects and some of which have undesirable effects, includes: THCA (mostly releasing bioactive compounds at 120 degrees centigrade, active at the range of 60-125 degrees), CBDA (130 degrees centigrade, and the range of 80-135 degrees), CBCA (140 degrees centigrade, and the range of 100-145 degrees), THC (a first release from Δ-9 compound at 155 degrees centigrade, a second release from Δ-8 compound at 175 degrees centigrade, its boil points are 157 and 177 degrees, respectively), CBD (165 degrees centigrade, and the range of 160-180 degrees), CBN (185 degrees centigrade which is also the boil point), CBE (195 degrees centigrade which is believed to be its theoretical boil point), Benzene (205 degrees centigrade), THCV (220 degrees centigrade, beyond its boil point), and CBC (220 degrees centigrade which is also the boil point). An object of the invention in the context of this example is to produce and capture such a profile of released substances which is similar to the “ideal” profile of conventional smoking. A non limiting exemplary list of herbal and organic materials which can be used for includes: Commiphora myrrha, burseeraceae, boswellia, Boswellia thurifera, Boswellia carteri, Boswellia sacra, Lavandula angustifolia, Salvia divinorum, psilocybin mushroom, Banisteriopsis caapi (ayahuasca, ayawaska), papaver (poppy opiates), coca (Erythroxylum coca, Erythroxylum novogranatense), civet oil (for civetone, taken from civets—viverridae, such as Civettictis civetta, deer musk (for muscone), herbal musk (taken from Herminium monorchis, Chamorchis alpine, Angelica archangelica, Malva, Fragaria moschata, Rosa moschata, Abelmoschus moschatus, Mimulus moschatus, Olearia argophylla, Sicana odorifera, Hibiscus moscheutos, Erodium moschatum, Carduus nutans, Ocotea moschata, Crassula moschata, Citrofortunella microcarpa, Amberboa moschata, Phymatosorus scolopendria, etc.), Ferula galbaniflua, galbanum, Ambergris (grey amber), nutmeg (Myristica fragrans), khat (Catha edulis), Ephedra, milk thistle, tobacco, hemp (cannabis), frankincense, incense, coffee, cacao, Chinese camellia, guarana, gyoza, ginseng, maca, arca catecho (palm), betel (peppers), Paraguay cynic, eleutherococcus.

Conventional extraction techniques fall short of providing the medical and recreational (e.g., tasty, aromatic) benefits of bioactive compounds which occur and are available only by burning and/or evaporation.

Cannabis is a unique botanical source material as the bio-active compounds are best extracted through vaporization or combustion (smoking). Conventionally, botanical sources are extracted through other techniques such as alcohol immersion, s-CO₂ or s-Butane. This process is similar to the process of squeezing the juice of a fruit. However, the ideal biologically active components, as well as the preferred aroma and user experience from cannabis and tobacco, can be derived only through combustion and vaporization.

It is another object of the present invention to facilitate extraction of components of the plant that are associated with the flavor, aroma and user sensation which can be used for an enhanced smoking experience while eliminating the harmful or potentially harmful constituents.

The disclosed invention uses vaporization and combustion to provide a commercial solution for higher quality extracts with a better therapeutic profile and a more pleasurable user experience.

Smoking cannabis generates a predictable effect, and it was found that vaporizing cannabis will produce a similar effect. To achieve such a predictable effect, it is critical to extract the cannabinoid profile and entourage that is similar to the “ideal profile” that can be achieved through smoking or vaping the cannabis plant.

A system or method according to the disclosed invention can be specifically designed for cannabis or tobacco extraction which will generate an extraction profile that is practically identical to smoking or vaping. The same ideal molecular spectrum as found in smoking or vaporizing of the cannabis plant, can be provided by a system or method according to the invention. This extract is more effective biologically that other conventional extraction techniques.

For tobacco, it may be desirable to extract all the components of the plant that are associated with the flavor, aroma and user sensation while virtually eliminating the harmful or potentially harmful constituents (HPHC's). The HPHC's are found both within the plant as well as generated during combustion, but the invention allows to either eliminate HPHC extraction or to easily remove dissolved harmful compounds from the tincture or an interim solution in which they are dissolved. Another object of the present invention is to provide a commercially viable system and method that can extract a full flavor, rich aroma tobacco oil, without the HPHC's.

In general, tobacco extraction conventional alternatives that are commercially available nowadays have fallen short of the above objects whereas they contain a high nicotine content, and do not provide an adequate replacement for the full smoking experience.

The extraction process according to the invention enhances the molecular spectrum associated with the smoking flavor and reduces HPHC's. The use of the harvested compounds for vaping results with an enhanced smoking experience with a better safety profile. Accordingly, tinctures extracted according to the invention are particularly suitable for providing a flavorful, rich aroma tobacco oil or tincture, without or with little HPHC's, which can be dull in nicotine, and which are particularly suitable for vaping as a means of smoke rehab, detoxification from nicotine and withdrawal from smoking addiction, in contrast to conventional vaping oils.

Information regarding hazardous constituents released from a cigarette or other smoking or vaping device, can be found for example in the book: Cigarette Smoke and Oxidative Stress (pp. 5-46), Chapter entitled “Tobacco Smoke Constituents Affecting Oxidative Stress” (Jan B. Wooten, Salem Chouchane, and Thomas E. McGratha, May 2007, DOI:10.1007/3-540-32232-9_2).

In a publication of The National Center for Biotechnology Information, entitled “How Tobacco Smoke Causes Disease The Biology and Behavioral Basis for Smoking-Attributable Disease: A Report of the Surgeon General” (2010) (https://www.ncbi.nim.nih.gov/books/NBK53014/#). It is stated that “Cigarette smoke is a complex mixture of chemical compounds that are bound to aerosol particles or are free in the gas phase. Chemical compounds in tobacco can be distilled into smoke or can react to form other constituents that are then distilled to smoke. Researchers have estimated that cigarette smoke has 7,357 chemical compounds from many different classes,” and “Cigarette smoke is formed by (1) the condensation of chemicals formed by the combustion of tobacco, (2) pyrolysis and pyrosynthesis, and (3) distillation products that form an aerosol in the cooler region directly behind the burning coal . . . the yields of the chemical constituents in tobacco smoke that present health concerns increased as the temperature increased from 300° C. to 1,000° C., but some compounds (e.g., acrolein and formaldehyde) reached their maximum yield at 500° C. . . . The temperature of tobacco that burns at the tip of a cigarette may reach 900° C. . . . .”

In an FDA Premarket Tobacco Application (PMTA) filed for IQOS Tobacco Heating System (THS) with Marlboro (2017) discusses reduced amounts of hazardous compounds in heatsticks with respect to combusted cigarettes (raw data in Table 2: “Comparison of HPHC Yields from Heatstick Aerosols and Combusted Cigarettes”, p. 34). Heatsticks are compared to combustion cigarettes (CC) and it is stated, among others, that “weight of the tobacco plug in the Heatstick is approximately 320 mg compared with the 550-700 mg of cut-filler found in CC” (p. 16), namely—approximately halved.

The system and method according to the invention readily provide a high yield capacity for generating a desirable tobacco alternative in a liquid formula or a pure vaporizable oil, in a cost-efficient process. In particular, the system and method according to the invention allows to manufacture a tincture for consuming or for producing e-liquid for vaping and other smoking devices, with particularly low amounts of hazardous constituents, by, inter alia, allowing to control combustion and evaporation temperatures.

In its broadest aspects, the disclosed invention harnesses different sonic techniques for stimulating and enhancing dissolution of fume in a solvent. The invention features the application of subsonic, supersonic, and/or ultrasonic techniques to a crude mixture of the solvent and the fume, where the fume, which is gaseous or formed of gas (e.g., air) and particles suspended in the gas, does not tend to dissolve, spontaneously or despite conventional efforts, in a solvent which is primarily in a liquid state. These techniques practically increase the surface area of the interface between the gaseous state fume and the liquid solvent, by tearing and dispersing the interfacial membrane separating the liquid solvent from the gaseous fume, overcoming solvent liquid surface tension and forcing collisions between fume particles and solvent vapors which tend to resort into a liquid state, to thereby stimulate, coerce and enhance the dissolving of the fume as a solute in the solvent. It will be appreciated that the terms “solute” and “dissolve” in the context of the invention herein are merely used in the sense that the “solute” is the species to be harvested by means of being able to blend, mix, dissolve, be suspended, or disperse in another species called “solvent” which solvent is used as a capturing and conveying liquid medium, and that “dissolving” or “dissolution” are not limited by any means to the creation of a chemical “solution” in which molecules of the solute are broken in the solvent, and as such should be interpreted in the broadest sense of referencing and including any chemical relation between one material termed “solvent” and another termed “solute”, such as the relation between different materials in a mixture, a blend, an emulsion, a suspension and the like, in which no chemical “dissolving” or interaction between the “solute” and the “solvent” necessarily occurs.

Subsonic technique features the creation of cavitation in the liquid solvent, by applying the phenomena by which an increase in the speed of a fluid occurs simultaneously with a decrease in static pressure (e.g., Bernouli's principle) such as when the solvent with the fume is streamed through a tube having a taper (e.g., a venturi), or a narrow, straitened, convergent-divergent, or constricted neck nozzle, or valve (which terms are interchangeable in the context of the invention, often referenced herein as “tube-neck” or “convergent-divergent” neck, nozzle, constriction, or effect) where it is choked (e.g., by using a convergent-divergent constriction, usually featuring a symmetric neck), after which a low pressure induces flash which may reach cavitation. It is noted that variations of spouts, nozzles, constricted tubes, tube-necks, and convergent-divergent necks can be applied for the creation of cavitation.

Supersonic technique features the inducing of a shockwave, such as by streaming the solvent with the fume through a tube with a narrow neck or constriction (e.g., de Laval, usually featuring an asymmetric neck), after which a shock wave exerts high dispersion forces on the liquid. It is noted that tube-necks, nozzles and convergent-divergent necks other than de Laval can be applied for the creation of a shockwave.

Theory teaches that when upstream conditions are subsonic, fluid velocity will increase as it flows through the smaller cross-sectional area of a constriction (due to conservation of mass principle). The convergent-divergent effect decreases static pressure (and therefore density) at the constriction. If the fluid is a liquid, a different type of limiting condition (also known as ‘choked flow’) occurs when the convergent-divergent effect acting on the liquid flow through the restriction causes a decrease of the liquid pressure beyond the restriction to below that of the liquid's vapor pressure at the prevailing liquid temperature. Choked flow is a limiting condition where the mass flow will not increase with a further decrease in the downstream pressure for a fixed upstream pressure and temperature. For homogeneous fluids in adiabatic conditions, the physical point at which choking would occur is when the exit plane velocity is sonic (Mach number of 1), and the mass flow rate would increase only when by density upstream would increase at the choke point. At that point, choked flow causes flashing and cavitation—the liquid will partially flash into bubbles of vapor and the subsequent collapse of the bubbles causes cavitation. Cavitation is quite noisy and can be sufficiently violent to physically damage valves, pipes and associated equipment. In effect, the vapor bubble formation in the restriction prevents the flow from increasing any further.

In other words, fluid media changes from liquid to vapor as a result from increase in fluid velocity at or just downstream of the flow restriction, such as a valve, nozzle, or spout port. Liquid flow stream passes through necking down, or contraction at the restriction. Just downstream of the physical restriction at the vena contracta, the diameter of the stream is the least, and fluid velocity is at its maximum. Increase in velocity at the vena contracta is accompanied by a substantial decrease in pressure. As the fluid stream expands into a larger area further downstream, velocity decreases and the downstream pressure, which should increase, never recovers completely to equal the pressure upstream. The pressure differential between the valve inlet and the vena contracta can lead to cavitation (and flashing). Should the pressure at the vena contracta drop below the vapor pressure of the fluid due to increased fluid velocity at this point, bubbles will form in the flow stream (cavitation occurs when the vena contracta pressure is less than the vapor pressure Pᵥ, while the pressure P₂ at the valve inlet is greater than Pᵥ). Formation of bubbles will increase greatly as vena contracta pressure drops further below the vapor pressure of the liquid. If pressure at the valve outlet remains below the vapor pressure of the liquid, the bubbles will remain in the downstream. If downstream pressure recovery is sufficient to raise the outlet pressure above the vapor pressure of the liquid, the bubbles will collapse, or implode, producing cavitation, and the system and the process is said to have flashed. High recovery valves tend to be more subject to cavitation, since the downstream pressure is more likely to rise above the liquid's vapor pressure. Accordingly, structural damage to the valve and adjacent piping in often the outcome of flashing and cavitation, as well as involving unsuitable noise, reduced effectiveness of the valve function. Valves prone to damage due to cavitation and flashing are widely used in a myriad of industrial applications such as piping, pumps, mixing of gasoline and air in a carburetor, propellers of airborne planes, helicopters and marine vessels, and the like. Accordingly, it is the conventional practice to apply preventive measures for eliminating this phenomenon of flashing and cavitation, which is commonly deemed highly undesirable (Control Valve Handbook, Fisher Controls International, Inc., 3^{rd} ed. (1999), pp. 135-138). For example, in jet engines, supersonic speed of the flowing fluid is directed to occur downstream of the valve (which forms the latter part of the engine)—outside the engine in the open air, to thereby eliminate engine damage while providing supersonic thrust.

De Laval nozzle primarily concerns supersonic shockwave of flowing gas, rather than liquid. Gas begins by flowing sub-sonically through the entry of the nozzle. As the nozzle chokes down, the gas accelerates, until it is moving at the sound speed. As the gas still has a pressure well above that of the outside medium, and so it continues to accelerate to supersonic speeds after passing through the narrow part of the nozzle. At subsonic linear velocities, the gas is compressible and sound (which is a longitudinal pressure wave) will propagate through the gas. The gas velocity at the throat of a de Laval nozzle, where the cross-sectional area is at a minimum, becomes sonic, commonly referred to as choked flow. As the nozzle's cross-sectional area increases in the divergent section, the linear velocity of the gas flow becomes supersonic as the gas expands and sound waves can no longer propagate backwards through the gas.

The disclosed invention harnesses the phenomenon of flashing and cavitation, which is conventionally undesirable, for increasing the surface area of fume bubbles immersed in the liquid solvent, increasing the pressure exerted on the fume bubbles membrane, and inducing violent collapse of the bubbles for enhancing dissolution of the fume as a solute in the solvent.

Ultrasonic technique features the application of ultrasound energy by an ultrasound transmitter for the creation of cavitation in a mixture of the solvent and the fume and/or for the increase of pressure on the tiny smoke bubbles (typically sized with diameters of 5-15 μm) within the liquid solvent. The application of ultrasound energy is orthogonally independent of the sub- or supersonic devices and accordingly can be located at or in the vicinity of any of the subsonic or supersonic convergent-divergent necks to superpose the ultrasonic stimulation with that of the subsonic/supersonic stimulation or in a separate location altogether as a separate measure for stimulation and enhancing dissolution (increase in pressure generally enhances dissolution of gaseous bubbles in liquid solvent)

Any combination of the three techniques can be applied for enhancing the dissolution or intermixture of the fume particles in the liquid solvent. In particular it is noted that a convergent-divergent neck, which can feature a venturi neck can also be a de Laval nozzle—wherein the only difference depends on the speed (subsonic, supersonic) and pressure by which the fluid (gas or liquid) is streamed, and accordingly a convergent-divergent neck can feature the two techniques at once, wherein both the cavitation and shockwave can occur at the same tube-neck. It is also possible to use an arrangement featuring one convergent-divergent neck (e.g., venturi) for the subsonic cavitation and another (e.g., de Laval) for the supersonic shockwave. Accordingly, a device according to the invention can merely feature just one of the three sonic techniques, can feature any two or all of the three techniques implemented in different modules in series, or can feature any two or all of the three techniques combined in a single module.

In addition, the application of any of the valves, nozzles, or tube-necks, such as those mentioned above, can also serve for the suction of fume, from any fume source (e.g., a combustion chamber), and accordingly the same valve (or separate valves) can serve two purposes: fume suction, and fume dissolution in a solvent. Fume deposits on such a suction valve do not tend to accumulate due to the powerful streaming therethrough (and if they do—can be easily removed therefrom) in comparison to a mechanical gas suction pump in which fume deposits rapidly accumulate. In addition, the suction valve can be disposed in immediate proximity to the fume source to thereby completely eliminate or shorten to the minimum any conduction piping from the fume source in which fume deposits may accumulate.

Moreover, a closed circuit circulation of the fume may be applied, using such valves, tube-necks as suction means, wherein the fume source is the gas remaining after having been streamed through the same or similar valves for the purpose dissolution in the solvent, and thereby repeatedly subjecting the fume to powerful coercion of dissolution by sub-, super-, and/or ultra-sonic forces, until a high percentage of the fume eventually dissolves. Without a closed loop gas circulation, pressure needs to be applied into the system, and thus the gas that escapes results in the loss of a substantial large portion of the fume (e.g., 75% escapes). Closed loop is particularly useful when the evaporated matter is not required to burn, as there is no need to introduce fresh air for oxygen enrichment. According to some embodiments, the very same convergent-divergent neck serves to provide the necessary suction of the fume, the mixing with the liquid solvent, the exertion of subsonic and/or supersonic and/or ultrasonic flash/cavitation phenomena, and the recirculation of gas and fume which have already passed through the tube-neck. In other embodiments, each particular convergent-divergent neck of a cascade of several convergent-divergent necks, is assigned to one (or more) particular task: suction of fume from a fume source (e.g., from a combustion chamber), mixing fume with the solvent in a mixing chamber, inducing dissolution by subsonic flash/cavitation, inducing dissolution by supersonic shock which may involve flash/cavitation, inducing dissolution by ultrasonic induction of flash/cavitation, and recirculation of gas and fume remaining after previous exposure to one, some or all of the dissolution inducing convergent-divergent necks.

Accordingly, the disclosed technique features a fume dissolution and accumulation harvester, system and method for dissolving and accumulating fume in a liquid solvent, by a sonic cavitation device which is configured to exert cavitation effect in a mixture of liquid solvent and fume (solvent-fume mix). The solvent may be ethanol, acetonitrile, propylene glycol, glycerol, water, methanol, organic solvent, and/or any combination of any of the above. The sonic cavitation device may be subsonic for exerting cavitation in the solvent-fume mix and/or supersonic for exerting a supersonic shockwave (usually in addition to exerting cavitation), when the solvent-fume mix streamed through a convergent-divergent neck, and/or ultrasonic for transmitting ultrasound energy into the solvent-fume mix. In this context, the term “fume” includes gas, as well as fume-particles, smoke, vapor, and/or mist, which is/are suspended (or dissolved, dispersed and/or distributed) in the gas.

According to some aspects of the invention there is thus provided a fume-dissolution harvester for dissolving and harvesting fume in a liquid solvent, featuring at least one sonic cavitation device configured to exert cavitation effect in a solvent-fume mix. The sonic cavitation device may include a convergent-divergent neck for exerting cavitation in the solvent-fume mix when streamed through the neck, which is a subsonic cavitation device, such as a venturi operational for a smooth or a choked flow, or a supersonic cavitation device, such as a de Laval nozzle operational for exerting a supersonic shockwave (e.g., having an over expanded nozzle configured to induce a free shock separation by satisfying Summerfield Criterion of P=0.4 . . . 0.35 Pa), and may be further operational for vacuum pumping of the fume. The at least one sonic cavitation device may include at least two sonic cavitation devices consecutively arranged in series along a streamline, such as a subsonic cavitation device and a supersonic cavitation device disposed downstream thereof, or to exert subsonic cavitation or supersonic cavitation in a single sonic cavitation device whose convergent-divergent neck is operative to exert cavitation effect and a supersonic shockwave.

The at least one sonic cavitation device may include an ultrasonic transmitter for transmitting ultrasound energy into the solvent-fume mix, wherein the ultrasonic transmitter may be configured to operate at frequency range of 0.7-5 MHz, and at intensity range of 0.3-20 Watt/Cm². The ultrasonic transmitter is disposed at a pool of the solvent and wherein the solvent-fume mix is released at the bottom of the pool to produce gaseous bubbles which rise through the pool while being exposed to ultrasound energy of the ultrasonic transmitter, and a series of horizontal perforated plates may be disposed in the pool for slowing down the rising of the gaseous bubbles in the pool, for prolonging exposure of the bubbles to the ultrasound energy, wherein the solvent-fume mix gushes out from another of the at least one sonic cavitation device. The at least one sonic cavitation device can include a convergent-divergent neck for exerting cavitation in the solvent-fume mix when streamed through the neck, wherein at least one ultrasonic transmitter is mounted at, or downstream in the vicinity of, or downstream away from, the neck or the vena contracta of the neck.

The convergent-divergent neck may be formed by an hourglass shaped tube, constricted in an intermediate section between an upstream inlet lobe into which the solvent-fume mix is streamed from a source of fume at an inlet-pressure and a jet of fog-sized liquid solvent droplets is sprayed via a spout nozzle, and a downstream outlet lobe in which an outlet-pressure is lower than the inlet-pressure to define a pressure difference between the inlet lobe and the outlet lobe, wherein the upstream inlet lobe tapers at an entry cone gradience toward the neck and the downstream outlet lobe tapers at an exit cone gradience toward the neck, to thereby induce cavitation effect and/or shockwave at the downstream outlet lobe. The constricted intermediate section may be asymmetrical wherein the entry cone gradience is different (e.g., greater—for facilitating the inducing of shockwave at said downstream exit lobe) from the exit cone gradience, and feature a venturi tube, wherein the entry cone gradience is 30 degrees or steep in the range of 5 to 40 degrees and the exit cone gradience is 5 degrees or is moderate in the range of 3 to 20 degrees, or feature a de Laval nozzle, wherein the exit cone gradience is greater than the entry cone, e.g., steep in the range of 10 to 40 degrees (e.g., 30 degrees) while the entry cone gradience is moderate in the range of 3 to 20 degrees (e.g., 5 degrees), for facilitating the inducing of shockwave at the downstream exit lobe. The downstream inlet lobe may include an L-shaped chamber connected downstream to the constricted intermediate section and having an upstream fume inlet from which a flow stream of the fume is streamed, wherein the liquid solvent spray is sprayed via a spout at an interim location facing the constricted intermediate section for sweepingly drifting the spray by the flow stream.

According to some aspects of the invention, by pumping vapor with a sonic device (subsonic or supersonic), fume and solvent can be provided without the need of a mechanical pump, which is often damaged or blocked as a result of greasy vapor that accumulates in the pump, and which is further encumbered with the losing of essential oils and other volatiles that adhere to the pump walls. Vapor and fume which are sucked with the solvent are immediately mix therewith. After the suction stage, the fume in the subsonic/supersonic device is contained inside the solvent in the form of micro-bubbles which are typically sized in the range of 5 to 100 microns. This mixture is streamed into a mixing chamber in which a sub-pressure sweeps the steam into the solvent. The mixture of solvent and fume enters the pressure nozzle, with myriad of tiny fume bubbles in the solvent. This subsonic/supersonic device or preferably—in another, second sonic device (e.g., sub-sonic and/or super-sonic constrain mixing chamber, such as of de Laval spout), the pressure increases and decreases due to changes in diameter of the tube through which it is streamed. An ultrasonic device featuring an ultrasound transducer (or double transducers facing one another) increases the surface area of the bubbles to break the micro-bubbles into even smaller-size bubbles. Pressure therefore is increased by means of change in subsonic/ultrasonic diameters, as well as by supersonic shockwaves, cavitation, and ultrasound wave transmission.

Ultrasound waves exert a pressure on micron bubbles—this pressure increases the absorption and dissolution of the substances contained inside the vapor, into the solvent. The “milky” liquid (solution mix) thereafter is required to undergo cooling (by cooling means) because the changes in pressure and application of ultrasound can overheat the solution mix. The milky liquid (“milky due to the myriad of vapor bubbles) will enter a “reactor”. Means to moderate the flow so are applied so that there will be no vortices at the reactor. Inside a bottom tank of the reactor, wherein a solution pool is rested, an array of ultrasound transducers (e.g., featuring 1, 2 or 4 transducers) transmits ultrasound energy. Transmission of ultrasound waves which can confront each other for increasing effect, exerts pressure on the bubbles and urges their dissipation into the solvent. The bubbles that are not absorbed in the solvent, rise and are released from the liquid in the tank pool at the bottom of the reactor, resembling release of CO₂ bubbles of a soda drink in an open vessel. The emitted gas in the reactor is not released into the atmosphere. Upon rising upwards, the gas and mist of solvent passes through a screen of solvent stream, a process that absorbs more fatty parts of the gas.

In the next stage of the reactor, the gas which is saturated with solvent (e.g., ethanol), passes through a cyclone device that separates the liquid particles contained in the gas by the centrifugal force of the cyclone. The collected particles are then condensed into a liquid on cool (or actively cooled) walls. The remaining gas is dry, namely does not contain solvent particles. The gas is then recirculated back to the furnace (or a subsequent stage) for another round together with fresh fume. In other words, the system which operates in a closed circuit, repeatedly sucks the recirculated gas as well as fresh vapors from the furnace. This way no vapors are lost, and the fume does not stick to the walls of the pipes and pumps (as it immediately encounters the pumping sonic device).

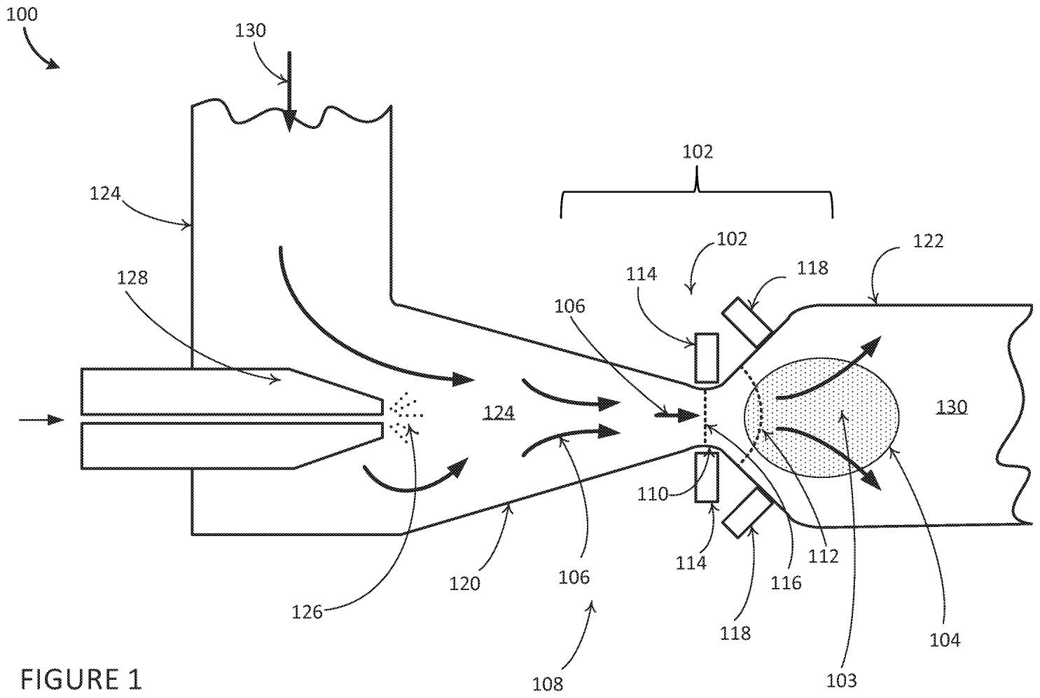

With reference to the Figures, it will be appreciated that like numbers designate like parts in different embodiments. Reference is now made to FIG. 1. FIG. 1 depicts an embodiment constructed and operative in accordance with the invention featuring a combined sonic fume-dissolution harvester, denoted 100, for stimulating and enhancing fume dissolution in a solvent by sub-, super-, and ultra-sonic constrains. Sonic fume-dissolution harvester 100 includes a sonic cavitation device 102 which is configured to exert cavitation effect in solvent-fume mix 103 in area 104, wherein solvent fume mix 103 is streamed in direction 106 along tube 108, and wherein the fume comprises gas and smoke, vapor, mist or fume-particles suspended in said gas. The solvent may be ethanol, acetonitrile, propylene glycol, glycerol, water, methanol, an organic solvent, and any combination of any of these examples. Sonic cavitation device 102 may be a subsonic cavitation device for exerting cavitation in solvent-fume mix 103 in area 104, when streamed through convergent-divergent neck 110. Alternatively, or in addition, sonic cavitation device 102 may be a supersonic shockwave device, represented by shockwave perforated line 112, for exerting a supersonic shockwave in solvent-fume mix 103 when streamed through convergent-divergent neck 110 (which is usually asymmetric in the supersonic context). Sonic fume-dissolution harvester 100 can include at least one ultrasonic transmitter for transmitting ultrasound energy into solvent-fume mix 103, such as transmitters 114 and 116. Transmitters 114 are disposed at the sides of the narrowest strait 116 of convergent-divergent neck 110 where the density of the streaming solvent-fume mix 103 is maximal where all particles even the central current is in close proximity to the transmitted ultrasound energy. Transmitters 114 may include merely one transmitter, or two transmitters that face each other to catch solvent-fume mix 103 in cross transmission, or several transmitters that encircle convergent-divergent neck 110. Transmitters 118 are disposed around tube 108 somewhat downstream of strait 116 of convergent-divergent neck 110 (where the velocity of the streaming solvent-fume mix is maximal), such as in the vicinity of the vena contracta of neck 110 or further downstream thereof, and may include merely one transmitter, transmitters that face each other to catch the solvent-fume mix in cross transmission, or several transmitters that encircle tube 108. Preferably, ultrasonic transmitters 114, 118 are configured to operate at frequency range of 0.7-5 MHZ, and at intensity range of 0.3-50 Watt/cm² (frequency and intensity may be selected at specific values or extend in the ranges of 0.7-5 MHz and 0.3-50 Watt/cm² respectively), which were found effective to induce cavitation in the fume solvent mix.

Convergent-divergent neck 110 is formed by an hourglass shaped tube, constricted in an intermediate section of tube 108 disposed between a cone shaped inlet lobe 120, also termed herein as entry cone 120 and cone shaped exit lobe 122, also termed herein as exit cone 122, through which solvent-fume mix 103 is streamed. Convergent-divergent neck 110 may be a smooth flow or a choked-flow constricted tube, depending on the dimensions and gradiences of entry cone 120 and exit cone 122. Convergent-divergent neck 110 may also function as a de Laval nozzle, when fume and air mix is streamed in adequate velocity and with adequate gradiences of entry cone 120 and exit cone 122. A de Laval nozzle usually includes an over expanded convergent-divergent neck, namely—with a moderate gradience of entry cone 120 and a steep gradience of exit cone, which is configured to induce a free shock separation when shockwave threshold conditions are met as is known, i.e., by satisfying Summerfield Criterion of P=0.4 . . . 0.35 Pa, where P is the downstream pressure at exit cone 122 and Pa is the upstream pressure at entry cone 120. In such a configuration, sonic cavitation device 102 combines a subsonic cavitation device and a supersonic shockwave combined in a single (usually asymmetric) convergent-divergent neck 110 which is operative to exert a cavitation effect, and if the velocity is increased to satisfy shockwave threshold conditions—to exert (in addition) a supersonic shockwave.

Neck 110 may be an asymmetrically constricted intermediate section wherein the entry cone gradience is different from the exit cone gradience. In some embodiments, the entry cone gradience may be greater than the exit cone gradience, for facilitating inducing cavitation at the downstream lobe. This constricted configuration may constitute a venturi, wherein the entry cone gradience is steep in the range of 5 to 40 degrees and the exit cone gradience is moderate in the range of 3 to 20 degrees. In a particular embodiment, the entry cone gradience may be 30 degrees and an exit cone gradience may be 5 degrees. In some embodiments, the exit cone gradience may be greater than the entry cone gradience, for facilitating inducing shockwave at the downstream lobe. This constricted configuration may constitute a de Laval nozzle, wherein the exit cone gradience is steep in the range of 5 to 40 degrees and the entry cone gradience is moderate in the range of 3 to 20 degrees. In a particular embodiment, the exit cone gradience may be 30 degrees and an entry cone gradience may be 5 degrees. It is noted that the terms ‘steep’ and ‘moderate’ herein are merely relative, namely, with reference to the case wherein one gradience is steeper relative to another, the former is deemed ‘steep’ and the latter ‘moderate’.

Alternatively, or in addition, sonic cavitation device 102 can also be operational for vacuum suction for pumping of fume present in inlet 124. Air-fume mix 130 is streamed via inlet 124 from a source of fume at an inlet-pressure Pa, and jet 126 of fog-sized liquid solvent droplets is sprayed via nozzle 128. Outlet lobe 122 in which an outlet-pressure P is lower than the inlet-pressure Pa, defines a pressure difference between inlet lobe 120 and the outlet lobe 122. Upstream inlet lobe 120 tapers as entry cone 120 at an entry cone gradience toward neck 102 and downstream outlet lobe 122 tapers at an exit cone gradience toward neck 102, to thereby induce cavitation effect and/or shockwave at downstream lobe 122.

In particular embodiments inlet lobe 120 includes an L-shaped chamber which is connected downstream to constricted neck 110 and to upstream fume inlet 124 from which a flow stream of the air and fume mix 130 is streamed. The liquid solvent spray is sprayed, as a jet of fog-sized liquid solvent droplets is sprayed via a spout such as nozzle 128 at an interim location facing constricted intermediate section containing neck 110 for sweepingly drifting the spray by the flow stream of the air and fume. Alternatively, or in addition to the particular L-shaped inlet lobe 120, a strong jet of solvent spray is operational to create a suction of the air and fume mix 130 from inlet 124 by virtue of the strong jet drift, to render device 100 as a suction pump of the air and fume mix.

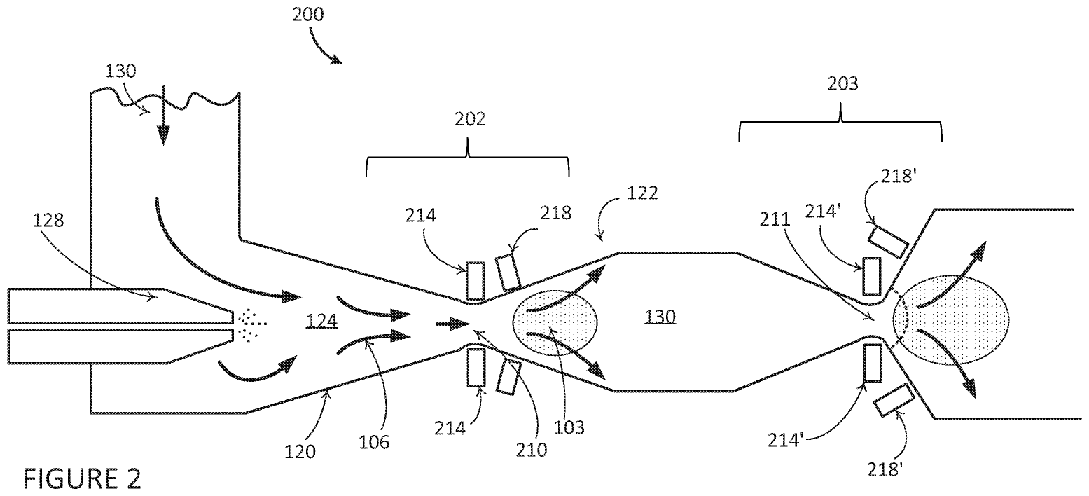

Referring now to FIG. 2, there's shown another embodiment constructed and operative in accordance with the invention, featuring a sonic fume-dissolution harvester, denoted 200, for stimulating and enhancing fume dissolution in a solvent by separate subsonic and supersonic constrictions, each combined with an ultrasonic constrain. Sonic fume-dissolution harvester 200 features a subsonic cavitation device 202, which can also function as air and fume pump, as is described with respect to harvester 102) and a subsonic/supersonic cavitation/shockwave device 203 which is disposed downstream of subsonic cavitation device 202. In this arrangement sonic fume-dissolution harvester 200 can serve as “double trap” in which device 202 serves as a subsonic cavitation device (e.g., a venturi) and device 203 serves a supersonic cavitation/shockwave device (e.g., de Laval), to enhance capturing of air and smoke by the solvent. The structural details of devices 202 and 203 are analogous to those described with reference to sonic cavitation device 102 of FIG. 1, and are also similar to those described below in further detail with reference to the embodiment of FIG. 3 and therefore are not recited, wherein similar components such as ultrasonic transmitters 214 (214′ for device 203) and 218 (218′ for device 203) are implemented in analogy to transmitters 114 and 118 of sonic cavitation device 102, respectively.

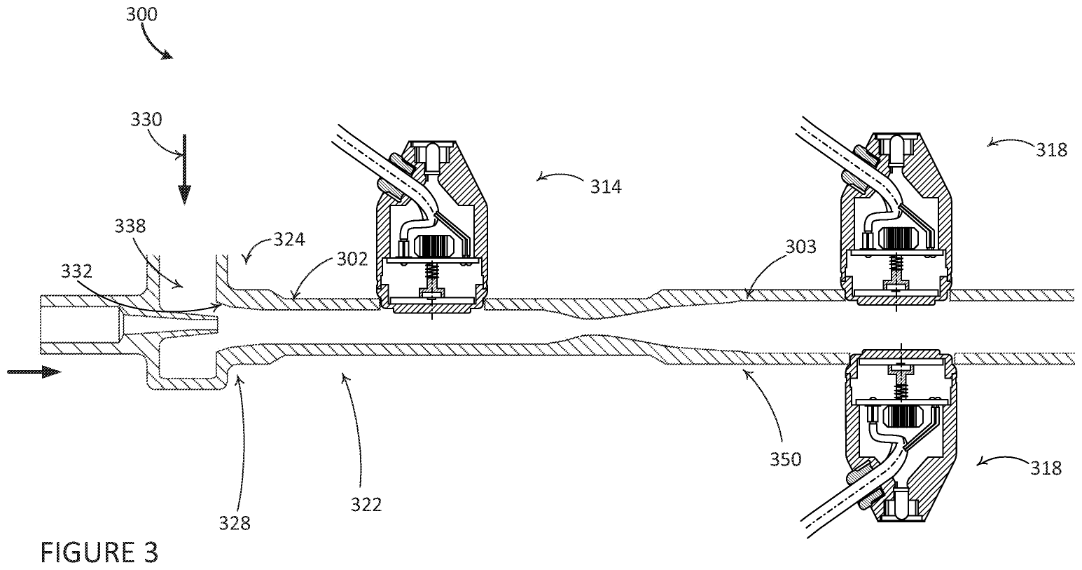

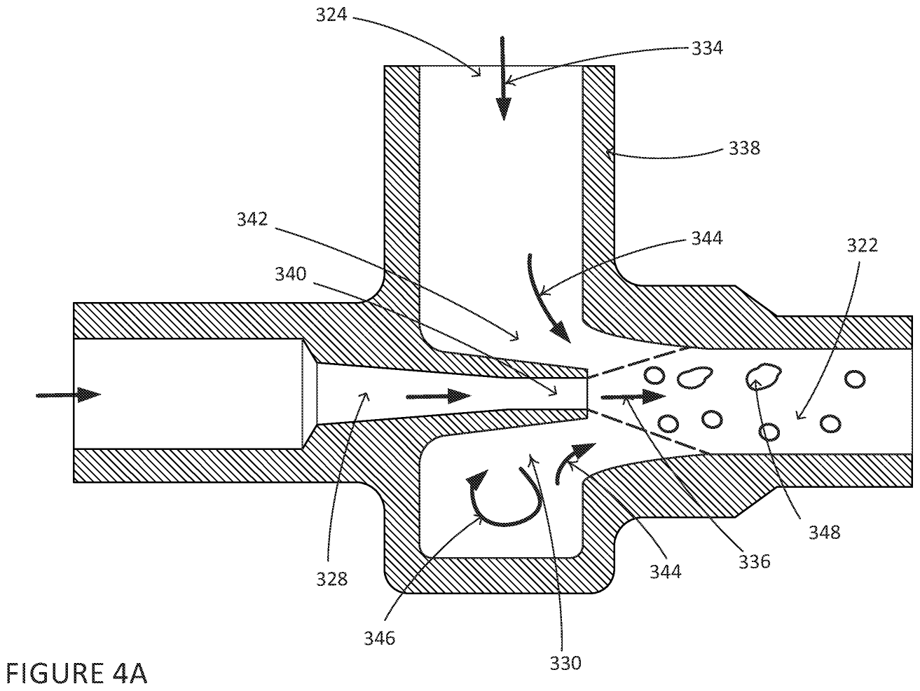

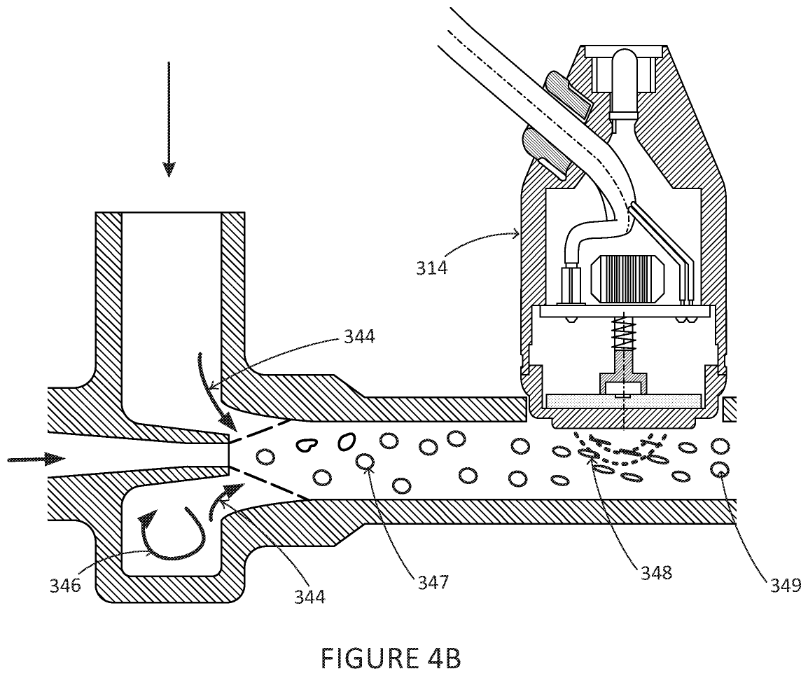

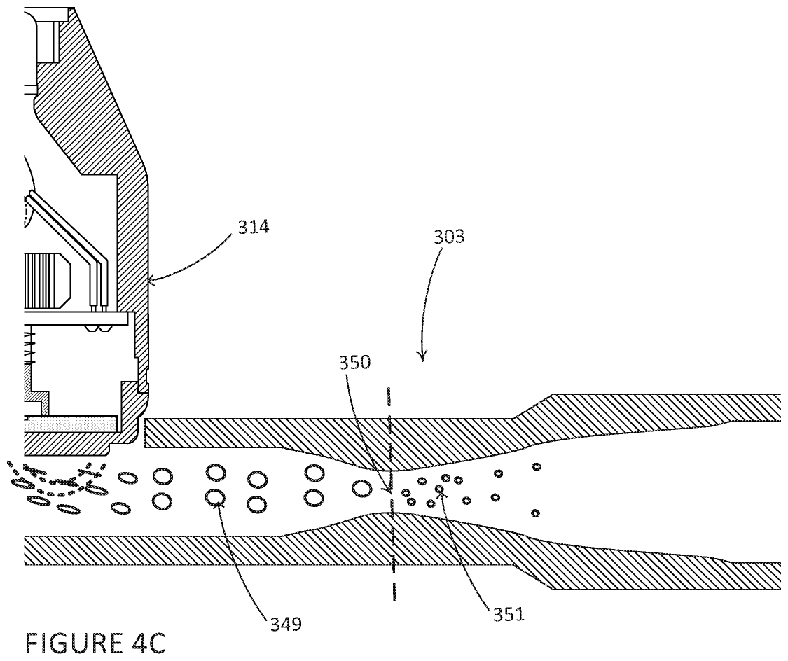

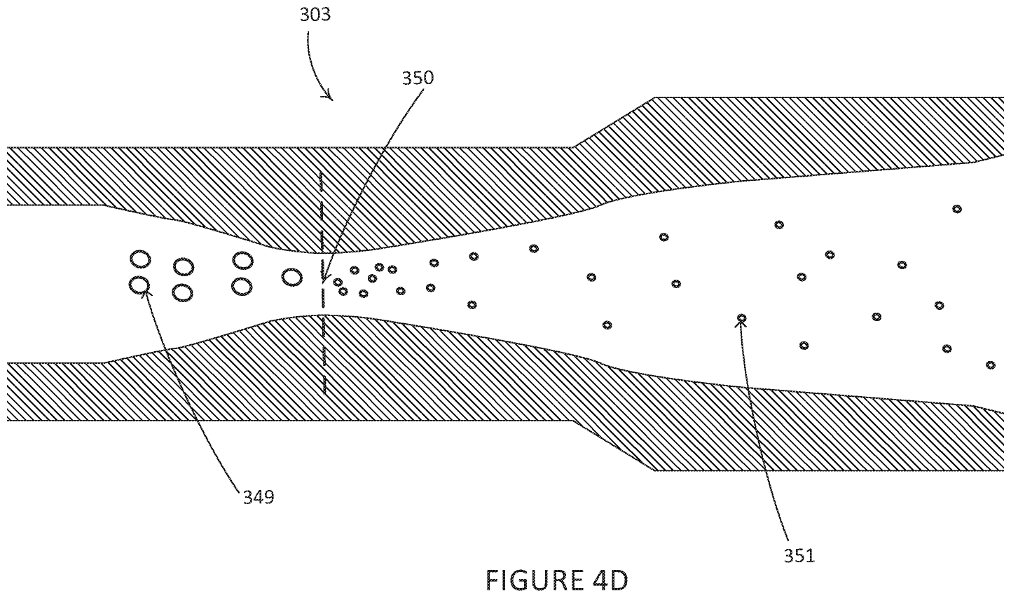

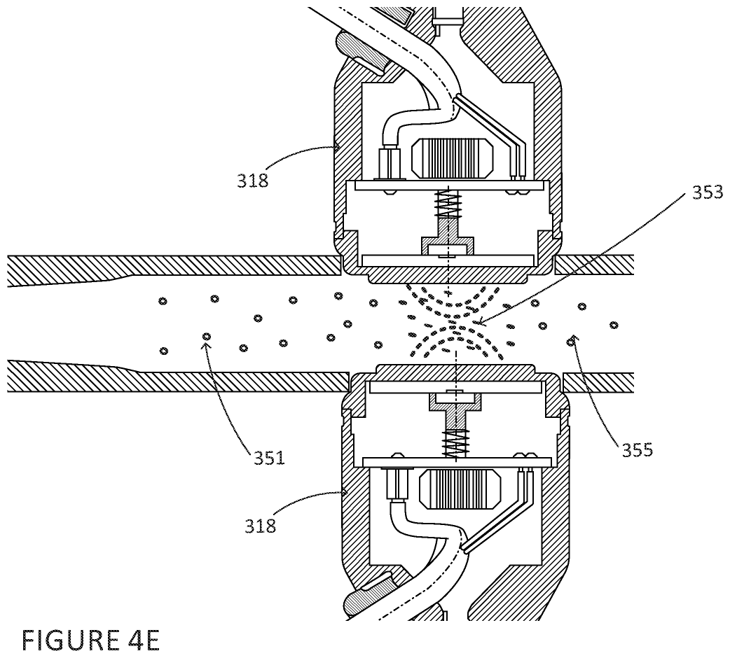

Reference is now made to FIGS. 3, and 4A to 4E. FIG. 3 depicts another embodiment constructed and operative in accordance with the invention, featuring a sonic fume-dissolution harvester, denoted 300, for stimulating and enhancing fume dissolution in a solvent by subsonic/supersonic constrictions, and separate ultrasonic constrains. Sonic fume-dissolution harvester 300 is similar to the double trap arrangement of sonic fume-dissolution harvester 200 of FIG. 2, with ultrasound transmitters displaced respective of constricted sections. Harvester 200 features suction/cavitation device 302, which functions as air and fume pump as well as a subsonic cavitation device similar to devices 102 and 202, and a subsonic/supersonic cavitation/shockwave device 303 which is disposed downstream of suction/cavitation device 302, similar to device 203. Ultrasonic transmitter 314 is disposed between suction/cavitation device 302 and cavitation/shockwave device 303, and ultrasonic transmitters 318 are deposed downstream of device 303.

FIGS. 4A to 4E are sequential enlarged partial views of sections of the embodiment of FIG. 3, with respect to which a description of the functional features of the embodiment of FIG. 3 and the processes undergoing therein will be now elaborated: FIG. 4A is an enlarged view of subsonic cavitation device 302 of sonic fume-dissolution device 300; FIG. 4B is an enlarged view of the section extending from subsonic cavitation device 302 to an ultrasonic transmitter 314 of sonic fume-dissolution device 300; FIG. 4C is an enlarged view of the section extending from ultrasonic transmitter 314 to subsonic/supersonic cavitation device 303 of sonic fume-dissolution harvester 300; FIG. 4D is an enlarged view of subsonic/supersonic cavitation device 303 of sonic fume-dissolution harvester 300; and FIG. 4E is an enlarged view of the section extending from subsonic/supersonic cavitation device 303 to ultrasonic transmitters 318 of sonic fume-dissolution harvester 300.

Device 302 features chamber 332, fume inlet 324, solvent inlet 328, and air and fume mixture outlet tube 322. Inlet 324 is in fluid communication with a fume source 330 from which fume, air and gas can freely enter (or is streamed by a streaming means) into chamber 332, and can be directed in perpendicular or at any convenient angle to the longitudinal direction 334 of incoming stream through fume inlet 324, such as of the stream through outlet tube 322, as depicted by arrow 336 in FIG. 4A. Outlet tube 322 is disposed in perpendicular to a wall 338 of chamber 332 and away from chamber's corners, so that a low pressure is allowed to be created in chamber 332 in the vicinity of outlet tube 322. Solvent inlet 328 features a tapering nozzle 340 through which liquid solvent is jet sprayed under pressure, wherein the jet spray is directed toward longitudinal direction 336 of the stream through outlet tube 322. The strong jet sweeps gas and fume lingering in chamber 332 toward outlet tube 322 and thereby creates a low-pressure zone 342 in chamber 332 proximate to outlet tube 322. Fume and air are drifted toward outlet tube 322 (arrows 344) while some air and fume trapped in a dead-end zone are forced to swirl in turbulence (arrow 346) until drifted upon encountering the low-pressure zone proximate to outlet tube 322. Accordingly, device 302 serves as a suction pump for drawing air and smoke from fume source 330.

Application of a closed loop circuit in which the gaseous matter can be repeatedly restreamed, conserves the precious (and air polluting) vapors for repeated dissolution by cavitation until most if not all the vapors are virtually dissolved and collected.

The drifted air and fume/smoke mixture splits up into bubbles 347 within the strong liquid solvent jet, which are sized between 5-100 μm (diameter in microns), and the stream at outlet tube 322 appears as a milky flash of a boiling or foamy liquid—as low pressure induces evaporation of liquid particles (venturi effect) which either join gas and fume bubbles (to thereby enhance dissolution), or merely remain in all-solvent bubbles. For efficiently dissolving gas in a liquid, the surface area of the bubbles may be induced to increase (e.g., the bubbles size is reduced) or the external liquid pressure may be increased. At this stage, the bubbles are subjected to ultra-sonic energy exerted by optional ultrasound transmitter 314 (a single transmitter is merely exemplary, a plurality of transmitters may be implemented as desired) which squeezes round bubbles into ellipsoidal bubbles 348 toward crushing into smaller micron sized (5-50 microns) and sometimes nanometre (nm) sized bubbles (denoted 349), to thereby enhance dissolution and absorption of the materials in the surface area of the bubbles in the solvent. The stream then enters a further constriction 350 of device 303 which may feature a subsonic cavitation, a supersonic cavitation, and/or shockwave cavitation device (e.g., venturi or de Laval), as explained above with respect to the embodiments of FIGS. 1 and 2. Bubbles 349 passing constriction 350 of device 303 are subjected to subsonic or supersonic cavitation, and/or shockwave cavitation (if M>1) which crushes 5-50 micron sized bubbles into nanometre sized bubbles 351 for enhancing fume dissolution. Downstream thereafter, bubbles 351 are further subjected to ultra-sonic energy exerted by optional ultrasound transmitters 318, which in this instance are exemplified by two oppositely disposed transmitters whose energy interact to create ultrasound wave super-positioning and interference patterns for increasing their overall effect (“squeezed” bubbles 353, and outgoing bubbles 355).

Further aspects of the invention disclose a fume-dissolution harvesting and accumulation system for accumulating fume in a solvent, for use of a dissolved-fume-extract dissolved and accumulated in the solvent or a fume-extract-concentrate distilled from the dissolved-fume-extract, the system including at least one fume-dissolution harvester for harvesting fume by dissolution in a liquid solvent and a fume generating compartment for burning and/or vaporizing fume-releasing source material (matter) for producing the fume provided to the at least one fume-dissolution harvester, wherein the fume generating compartment may be configured to produce a portion of the fume by exposure of the fume-releasing source material to combustion at burning temperatures, and another portion of the fume by exposure of the material to evaporation temperatures. The fume generating compartment may include an intermittent fume-generation inducer for inducing intermittent burning or heating of the matter to avoid pyrolysis. The fume generating compartment may include an optional aerator for oxygenating combustion. The intermittent fume-generation inducer may include an air pump (which can feature the aerator), a balloon vaporizer, and/or a valve, for inducing, conducting, or allowing intermittent flow of gas into or from the fume generating compartment, or a controller operational to control the intermittent burning or heating. The intermittent fume-generation inducer may be operational to repeat the intermittent heating at the intrinsic temperature of at least one specific compound or at successively/progressively rising intrinsic temperatures of respective ones of said at least one specific compounds for separately vaporizing said at least one specific compound to allow their respective separate collection.

Some embodiments of the invention disclose a fume-dissolution harvesting and accumulation system for accumulating fume in a solvent, which included at least one fume-dissolution harvester for harvesting fume by dissolution in a liquid solvent, and a closed loop gas circulation (e.g., including piping and a recirculation blower) for recirculating under pressure gas-fume mix remainder separated from the liquid solvent downstream of a receptacle for accumulating the fume as a solute dissolved in the solvent (“dissolved-fume extract”), into the at least one fume dissolution harvester, a preliminary fume and solvent mixing chamber disposed upstream of the at least one fume dissolution harvester, and/or a fume generating compartment.

Some embodiments of the invention disclose a fume-dissolution harvesting and accumulation system for accumulating fume which includes the at least one fume-dissolution harvester for harvesting fume by dissolution in a liquid solvent, and at least one of: a fume generating compartment for burning and/or vaporizing matter for producing the fume provided to the at least one fume-dissolution harvester; vaporization, combustion, and/or heating means for inducing the burning and/or vaporizing in the fume generating compartment; an aerator for oxygenating combustion in the fume generating compartment; a fume conveying conduit for conveying fresh fume from the fume generating compartment into the at least one fume dissolution harvester; a fume blower for drawing fume through the conveying conduit; a preliminary mixing chamber for enhancing dissolution of fume in liquid solvent before entering the at least one fume dissolution harvester; a tincture receptacle featuring a tincture pool, for engorging fume particles dissolved in liquid solvent and harvested by the at least one fume dissolution harvester; a solvent reservoir for supplying solvent to the liquid solvent pool, the at least one fume accumulator, and/or for conduit residue collection and cleansing; piping for conducting the fume-solvent mix from the fume at least one dissolution harvester to the tincture receptacle; a solvent-fume cooler for cooling heated solvent-fume mix downstream of the at least one fume dissolution harvester before streaming into the tincture receptacle; an ultrasound transmitter for transmitting ultrasound energy into the solvent-fume mix along piping of the system; an ultrasonic transmitter disposed in a pool of said solvent and wherein said solvent-fume mix is released at the bottom of said pool to produce gaseous bubbles which rise through the pool while being exposed to ultrasound energy of said ultrasonic transmitter; a series of horizontal perforated plates disposed in said pool and operational for slowing down the rising of said gaseous bubbles in said pool, for prolonging exposure of said bubbles to said ultrasound energy, wherein said solvent-fume mix gushes out from another of said at least one sonic cavitation device; a receptacle precipitation separator for separating gas and fume from liquid solvent upon reaching the receptacle from the at least one fume dissolution harvester or upon emitting from the solvent pool; a cyclone separator for separating cooled gas-fume mix from liquid solvent, downstream of the fume receptacle; a solvent condenser for condensing solvent remainder after cyclone separation downstream of the cyclone separator; eaves for conducting liquidized matter (solvent and solute) to the pool, from the receptacle precipitation separator, the cyclone separator, and/or the condenser; solvent circulation for feeding liquid solvent or tincture from the pool or a solvent reservoir to the at least one fume dissolution harvester or the preliminary mixing chamber, including piping and a solvent drawer; an internal conduit residue collection cleansing mechanism operative for washing piping and conduits of the fume dissolution harvester system with the liquid solvent for releasing fume residue adhered to the sides of the conduits, and for circulating the liquid solvent with the released fume through the conduits to the pool; an intermittent fume-generation inducer for inducing intermittent burning or heating of the matter in the fume generating compartment to avoid pyrolysis; at least one of: an air pump/aerator; a balloon vaporizer; and a valve of the intermittent fume-generation inducer for inducing, conducting, or allowing intermittent flow of gas into or from the fume generating compartment; a controller of the intermittent fume-generation inducer operational to control the intermittent burning or heating; the intermittent fume-generation inducer configured to repeat the intermittent heating at the intrinsic temperature of at least one specific compound or at successively/progressively rising intrinsic temperatures of respective ones of the at least one specific compounds for separately vaporizing the at least one specific compound to allow their respective separate collection; a closed loop gas circulation including piping and a recirculation blower for recirculating under pressure gas-fume mix remainder separated from the liquid solvent downstream of the receptacle into at least one of: the at least one fume dissolution harvester, the preliminary fume and solvent mixing chamber disposed upstream of the at least one fume dissolution harvester, and the fume generating compartment; a solvent remover for distilling fume-extract-concentrate by removal of solvent therefrom, which may feature an evaporator such as a pressure reducing-, a rotary-, or a centrifugal-evaporator; and a controller for controlling operation of system components, and setting and controlling system parameters, such as time duration of operation, total weight of matter to be processed solvent weight before and after the process, pre-set temperature at a fume generator compartment, pressure of liquids, air/gas pressure, vacuum pressure, weight of ash, the degree of turbidity of the solvent for indicating the absorption level of the fume, optical means for qualitative or quantitative measurement of dissolved components, and at least one temperature sensor for monitoring and controlling evaporation or combustion heat.

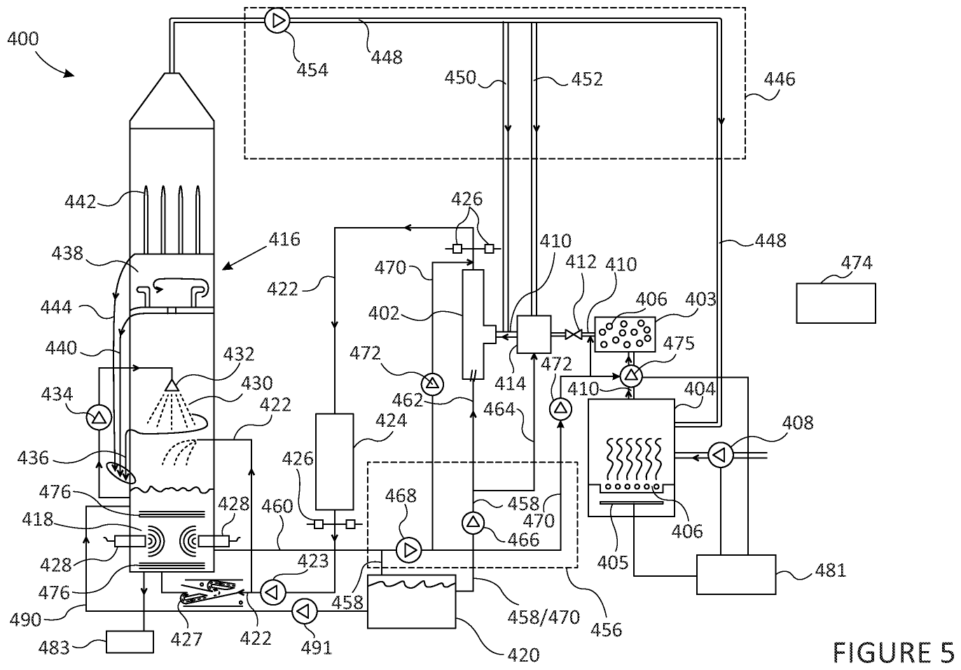

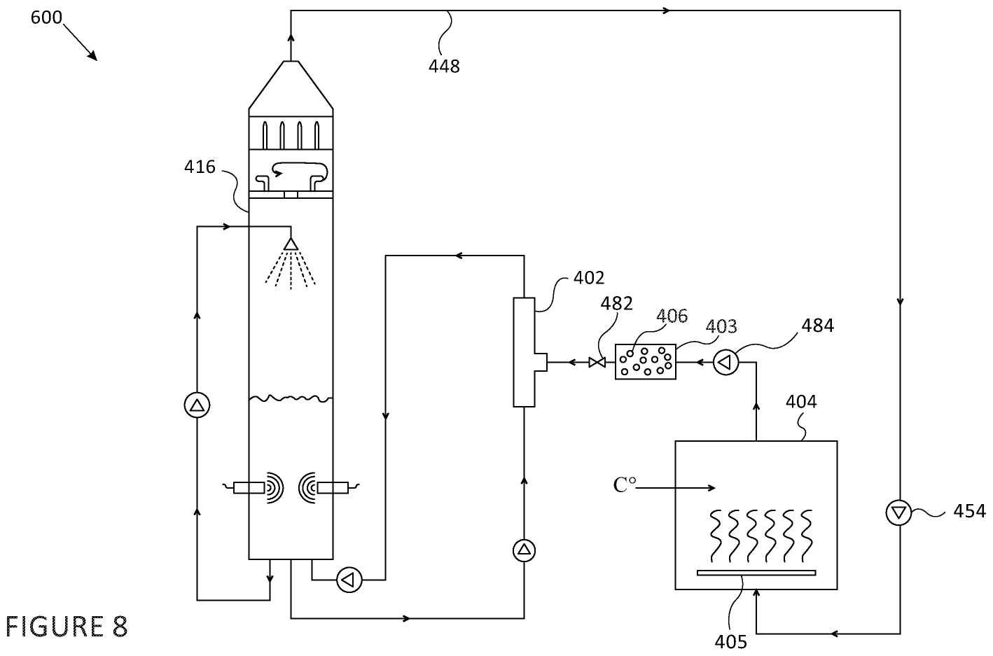

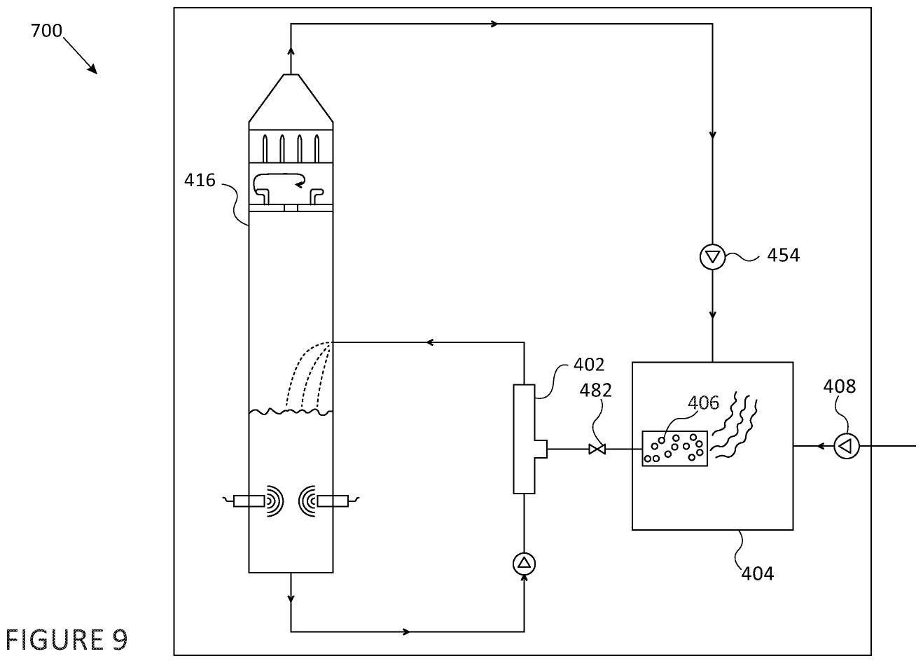

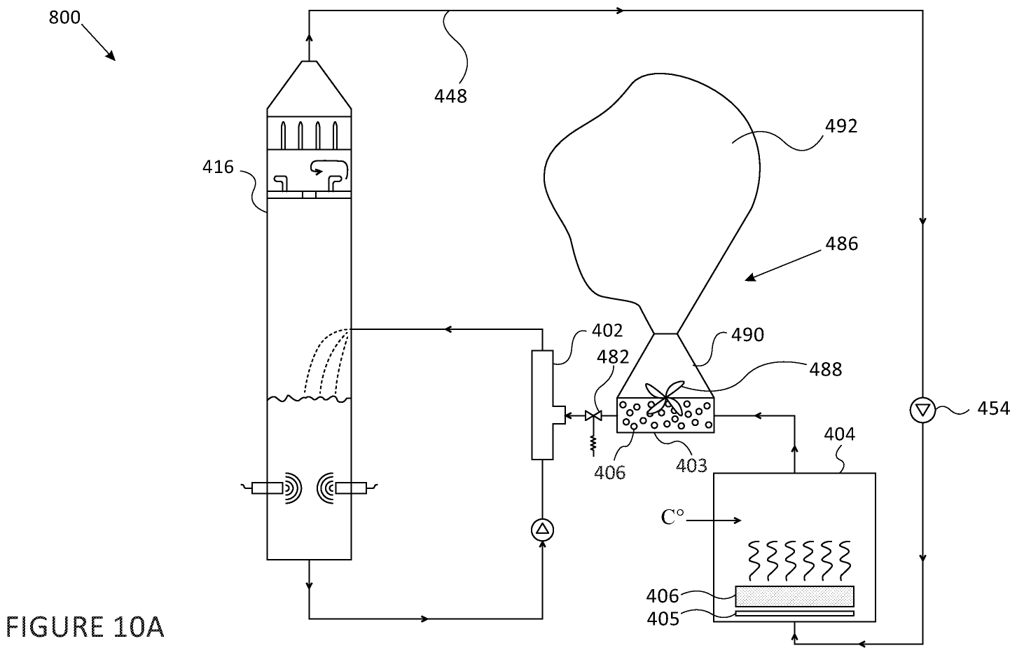

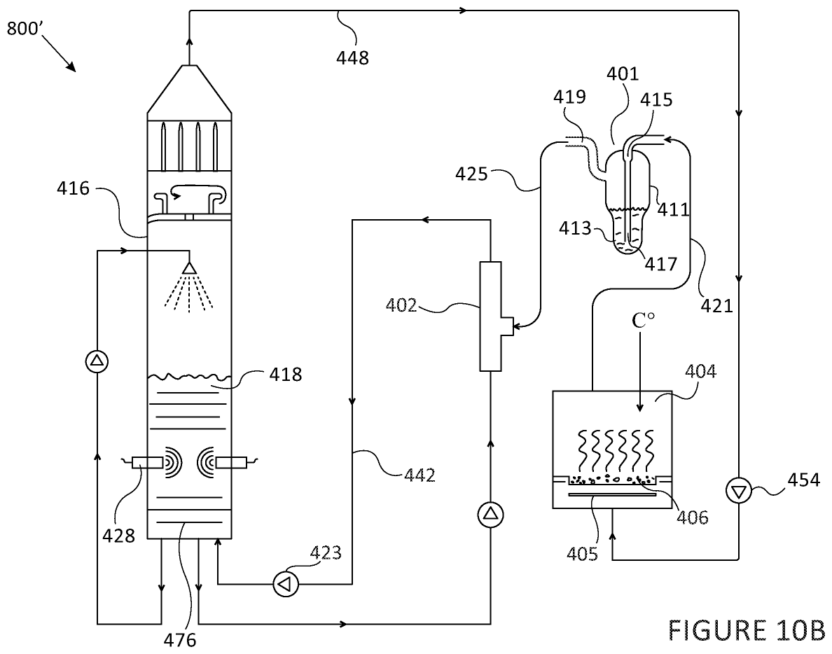

Reference is now made to FIG. 5. In FIG. 5, there is shown a fume dissolution and accumulation system, denoted 400, for accumulating fume in a solvent constructed and operative in accordance with the invention, which includes sonic fume-dissolution harvester 402 which may be a sonic fume-dissolution harvester according to the embodiments of FIG. 1, 2, or 3. System 400 further includes the following optional features, each one of which may be implemented without some of the others in variational systems:
1. Fume generating compartment 404, which may be an oven, stove, or a heating chamber, and which may feature vaporization/combustion/heating means 405 for continuously burning and/or vaporizing matter 406 for producing the fume, and optional aerator 408 for oxygenating combustion;
2. Fume conveying conduit 410 for conveying fresh fume from fume generating compartment 408 into sonic fume-dissolution harvester 402, which may feature fume blower 412 (and further optionally featuring a heating chamber 403, as described in reference with FIG. 8);
3. Preliminary mixing chamber 414 for enhancing dissolution of fume in liquid solvent before entering sonic fume-dissolution harvester 402;
4. Tincture receptacle 416 featuring tincture pool 418 for engorging harvested fume particles dissolved in liquid solvent resting in tincture pool 418;
5. Solvent reservoir 420 for supplying solvent to pool 418, (via piping 490 and pump 491) sonic fume-dissolution harvester 402 (via piping 462 and pump 466), and for optional conduit residue collection and cleansing (via piping 470 and pumps 472);
6. Piping 422 for conducting the fume-solvent mix from sonic fume-dissolution harvester 402 to tincture receptacle 416, which may feature pump 423;
7. Solvent-fume cooler 424 for cooling heated solvent-fume mix downstream of sonic fume-dissolution harvester 402 before streaming into receptacle 416;
8. Ultrasound transmitters such as transmitters 426 for transmitting ultrasound energy into the solvent-fume mix along the piping of the system, such as at piping 422 downstream of sonic fume-dissolution harvester 402;
9. A turbulence unit for enhancing dissolution, such as Tesla valve 427 (e.g., based on a valve as disclosed in U.S. Pat. No. 1,329,559 to Tesla), disposed right before streaming into receptacle 416. At this phase the solvent pressure has dropped (e.g., to 0.2-1 bar) and the passing of the bubbles-rich milky solvent-fume mix via Tesla valve 427 in the “resisting” direction, configured for slowing the stream, but not to the extent of completely blocking the current, and for creating vortices and turbulent flow, thereby exerts pressure on the bubbles for enhancing dissolution.
10. Ultrasonic transmitters 428 for transmitting ultrasound energy into the tincture at pool 418 wherein the solvent-fume mix is released at the bottom of pool 418 to produce gaseous bubbles which rise through pool 418 while being exposed to ultrasound energy of ultrasonic transmitters 428;
11. A series of horizontal perforated plates 476 disposed in pool 418 and operational for slowing down the rising of the gaseous bubbles in pool 418, for prolonging exposure of the bubbles to the ultrasound energy, wherein the solvent-fume mix gushes out from harvester 402;
12. Receptacle separator, such as precipitation separator 430, for separating gas and liquid upon reaching or arriving at receptacle 416 from sonic fume-dissolution harvester 402 or upon emitting from pool 428, such as by showering, sprinkling or drizzling from shower head 432 solvent drops drawn by pump 434 from tincture pool 418 or solvent reservoir 420, and which may feature optional eaves 436 for conducting liquidised solvent and solute to pool 418;
13. Cyclone separator 438 for separating between gas-fume mix and solvent evaporating upwards from fume receptacle 416 and are cooled down and whirled therein, which may feature optional eaves 440 for conducting liquidised solvent and solute which condense at separator 438 back to pool 418;
14. Solvent condenser 442 for condensing solvent remainder after cyclone separation by further cooling, which may feature optional eaves 444 for conducting liquidised solvent and solute to pool 418;
15. Eaves for conducting liquidized matter (solvent and solute) to pool 418, such as eaves 436 from precipitation separator 430, eaves 440 from cyclone separator 438, and eaves 444 from solvent condenser 442;
16. Closed loop gas circulation 446 for recirculating under pressure, into sonic fume-dissolution harvester 402 and/or preliminary mixing chamber 414 and/or fume generating compartment 404, gas-fume mix remainder emitted from receptacle 416 (after separation from liquidised solvent and solute by precipitation inducer 430, cyclone separator 438 and solvent condenser 442) featuring piping 448, 450, and 452 and recirculation blower, such as pump 454;
17. Solvent circulation 456 for feeding liquid solvent/tincture from solvent reservoir 420 (via piping 458) or pool 418 (via piping 460) to sonic fume-dissolution harvester 402 (via piping 462) or mixing chamber 414 (via piping 464), featuring a solvent drawer, such as pump 466 or 468;
18. An internal conduit residue collection cleansing mechanism, represented by perforated piping 470 and pump 472, operative for washing piping and conduits of fume accumulation system 400 with the liquid solvent for releasing fume residue adhered to the sides of the conduits, and for circulating the liquid solvent with the released fume residue through the system conduits;
19. Intermittent fume-generation inducer 481 for inducing intermittent burning or heating of said matter in fume generating compartment 404 to avoid pyrolysis (e.g., by controlling electric heating elements 405, incoming air pump 408, and/or outgoing air and smoke pump 475);
20. Air pump or aerator 408; balloon vaporizer 486 (as in FIG. 10); and valve 482 (FIG. 9) of intermittent fume-generation inducer 481 for inducing, conducting, or allowing intermittent flow of gas into or from fume generating compartment 404;
21. A controller which can be part of intermittent fume-generation inducer 481, or a separate controller operating in collaboration therewith such as controller 474, which is operational to control intermittent burning or heating;
22. Intermittent fume-generation inducer 481 which is configured to repeat the intermittent heating at the intrinsic temperature of at least one specific compound or at successively/progressively rising intrinsic temperatures of respective ones of the at least one specific compounds for separately vaporizing the at least one specific compound to allow their respective separate collection;
23. solvent remover 483 for distilling fume-extract-concentrate by removal of solvent therefrom, which may feature an evaporator such as a pressure reducing evaporator, a rotary evaporator, or a centrifugal evaporator; and
24. Controller 474 for controlling operation of system components mentioned above, and setting and controlling system parameters, such as:
   i. time duration of operation;
   ii. total weight of matter to be processed;
   iii. solvent weight before and after the process;
   iv. pre-set temperature at a fume generator compartment;
   V. pressure of liquids;
   vi. air/gas pressure;
   vii. vacuum pressure;
   viii. weight of ash;
   ix. the degree of turbidity of the solvent for indicating the absorption level of the fume;
   x. optical means for qualitative or quantitative measurement of dissolved components;
   xi. at least one temperature sensor for monitoring and controlling evaporation or combustion heat.

The operation of system 400 will now be discussed. Fume generating compartment 404 is fluidly connected by fume conveying conduit 410 to sonic fume-dissolution harvester 402 or preliminary mixing chamber 414 which is connected to sonic fume-dissolution harvester 402. Accordingly, fume streams from fume generating compartment 404 to sonic fume-dissolution harvester 402, directly or via preliminary mixing chamber 312. Sonic fume-dissolution harvester 402 is fluidly communicated by piping 422 to tincture receptacle 416 to stream solvent-fume mix thereto and via ultrasound transmitters 426 and solvent-fume cooler 424 which are disposed along piping 422. Ultrasound transmitters (e.g., 426, 428, and 114, 116, 214, 214′, 216, 216′, 314, 318 of FIG. 1-3) which may be deployed in different parts of system 400 increase local pressure which is essential for the dissolution of fume in solvent but bear insignificant overall pressure to the general gas circulated through the system, and thereby eliminate the need of massive pumps require to create high pressure and to compensate for pressure loss. This is particularly beneficial for the closed loop pattern of system 400 in which gas can be recirculated at a relatively low pressure, and eliminates the need to release valuable fume containing gas at high pressure.

Dissolution may also be enhanced by passing the solvent-fume mix in the resisting direction of an optional turbulence unit featuring Tesla valve 427, right before streaming into tincture receptacle 416. The resisting direction of Tesla valve 427 is configured for slowing the stream and for creating vortices and turbulent flow, which thereby exert pressure on the bubbles for enhancing dissolution.

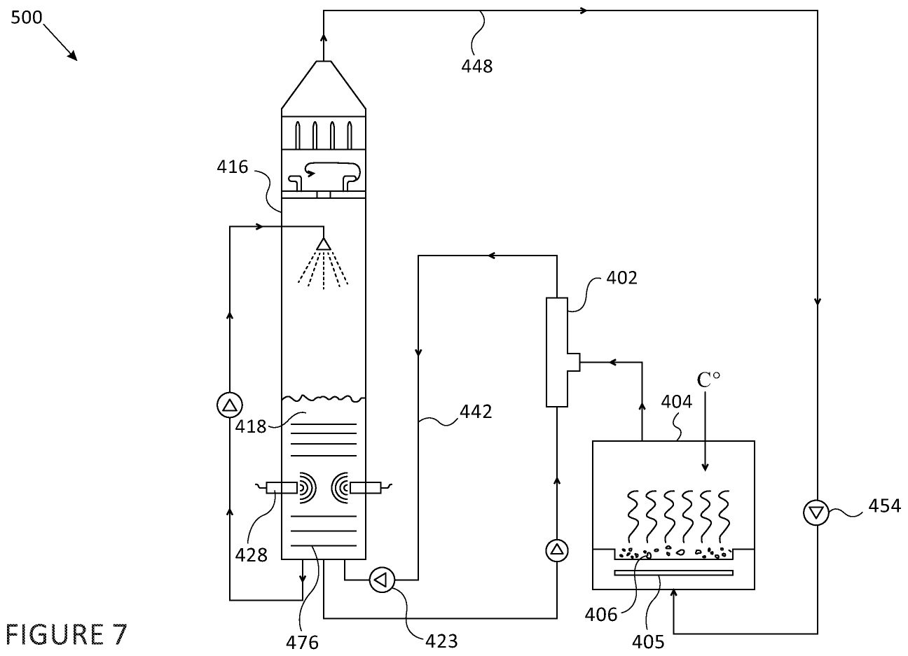

Optional ultrasound transmitters 428 may be employed for transmitting ultrasound energy into the tincture at pool 418 to enhance dissolution of fume particles in the tincture at pool 418. To enhance this dissolution, the solvent-fume mix is conducted through piping 423 to the bottom of pool 418 in receptacle 416, to allow the bubbles of the mix to rise afloat through the liquid in pool 418—wherein the bubbles are subjected to the ultrasound energy of transmitters 428 which are disposed at the sides or within pool 418, as best seen in FIG. 7 (piping 422, pump 423, pool 418 in receptacle 416, ultrasound transmitters 428 and plates 476). The mixture can be streamed by the assisting power of pump 423 which can feature for example a venturi water pump which is commonly used for the oxidation of aquarium water. Movement of the bubbles is preferably slowed down to allow increase of exposure to the transmitted ultrasound energy, e.g., by a series of perforated horizontal discs or plates 476 which are disposed one above the other leaving gaps in between within pool 418. The discs are perforated by small holes, which are preferably vertically displaced respective of the small holes of neighbouring discs. The bubbles which rise afloat encounter the discs which slow them down until they penetrate the small holes and the vertical displacement between the holes of neighbouring discs further slows their movement and urges the bubbles to accrete into larger bubbles. Amidst discs 476, two or four ultrasound transmitters 428 are disposed for effective exposure of the slowed down accreted bubbles to ultrasound energy. Bubbles subjected to this ultrasonic energy are urged to crush and dissolve in the liquid solvent which appears like a bubbling soda and rise and condense into a mist as they cool down upon leaving liquid pool 418.

Upon entering receptacle 416, the solvent-fume mix is initially separated by receptacle separator 430, wherein the liquidised matter drips, directly or through optional eaves 436, to join the liquid solvent resting at bottom pool 418, while gaseous matter (e.g., air, fume and solvent vapours, which appears as a mist) rises upwards towards cyclone separator 438. Matter liquidised at separator 438 drips, directly or through optional eaves 440, to join the liquid solvent resting at bottom pool 418, while gaseous matter rises upwards toward gas-fume condenser 442. Optional dripping curtain represented by dripper (or shower head) 432 may enhance further absorption of fatty matter in the gaseous mist back into pool 418. Separator 438 may feature a cyclonic construction that further separates liquid from gas by virtue of centrifugal force coerced by the cyclonic structure. The gas saturated with the solvent then rises to pass through condenser 442, in which a coolant liquid is passed through interlaced piping at a temperature below the condensation temperature of the solvent. For example, if the solvent is ethanol, the coolant may be water streamed through piping at a temperature below 4 degrees centigrade (and above the water freezing point of 0 degrees centigrade) which is the condensation temperature of ethanol.

Matter liquidised by condenser 442 drips, directly or through optional eaves 444, to join the liquid solvent resting at bottom pool 418, while gaseous matter which rises upwards is dry of solvent and is recirculated by closed loop gas circulation 446, by virtue of its rising or being expelled by pump 454, through piping 448, 450, 452, which fluidly communicate gas released from receptacle 416 (emitted from condenser 442) to Sonic fume-dissolution harvester 402 and/or mixing chamber 414 and/or fume generating compartment 404.

Solvent reservoir 420 is in fluid communication with pool 418 for supplying the solvent necessary for the operation of system 400. Solvent circulation 456 feeds liquid solvent or tincture drawn by pump 466 from reservoir 420 through piping 458 or tincture from pool 418 via conduit 458 and pump 468, to Sonic fume-dissolution harvester 402 or preliminary mixing chamber 414 (via piping 464). Solvent reservoir 420 is further fluidically connected to optional internal conduit residue collection cleansing mechanism to stream solvent drawn by pump 472 through piping 470 to wash piping and conduits (e.g., 410, 422, 436, 440, 444, 448, 450, 452, 458, and 464) for releasing fume residue adhered to the sides of the conduits, by circulating the liquid solvent with the released fume through the conduits. The fume-residue-rich solvent may be then circulated to pool 418 for aggregating the fume residue with the fume engorged in receptacle 416.

When fume is exhausted, or the accumulation operation of system 400 is halted for harvesting or for any other reason, or if the tincture at pool 418 is provided to another container, the fume dissolved, accumulated and engorged in liquid solvent pool 418 to thereby constitute a tincture which is the dissolved-fume-extract, may be separated from the solvent (or its concentration increased) to distil a fume-extract-concentrate, by heating the tincture above the solvent boiling temperature and below the dissolved fume evaporation/boiling temperature, wherein the solvent is selected to be with a boiling/evaporation temperature point which is lower than that of the dissolved fume evaporation/boiling temperature point, to thereby leave a residue of accumulated fume-matter if all the solvent is evaporated, or solvent-sparse, fume-rich tincture if some solvent remains. Distillation may also be carried by solvent remover 483 which may feature an evaporator such as a pressure reducing evaporator, a rotary evaporator, or a centrifugal evaporator, which effectively remove solvent from the dissolved-fume-extract to yield fume-extract-concentrate.

Controller 474 is configured and operational for controlling operation of any and all components of system 400, and for setting and controlling system parameters.

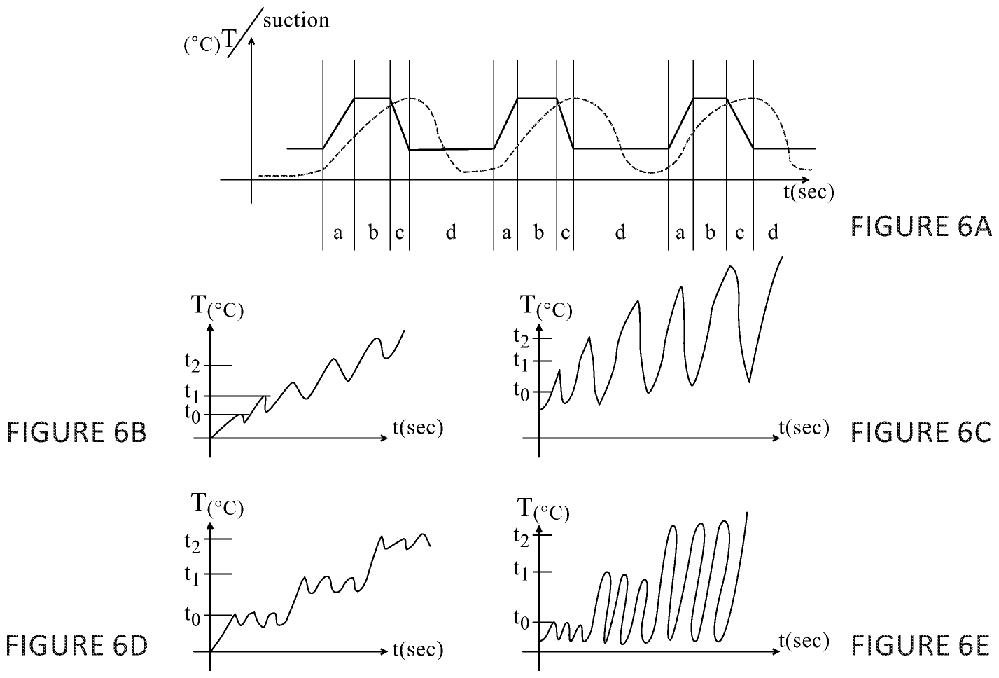

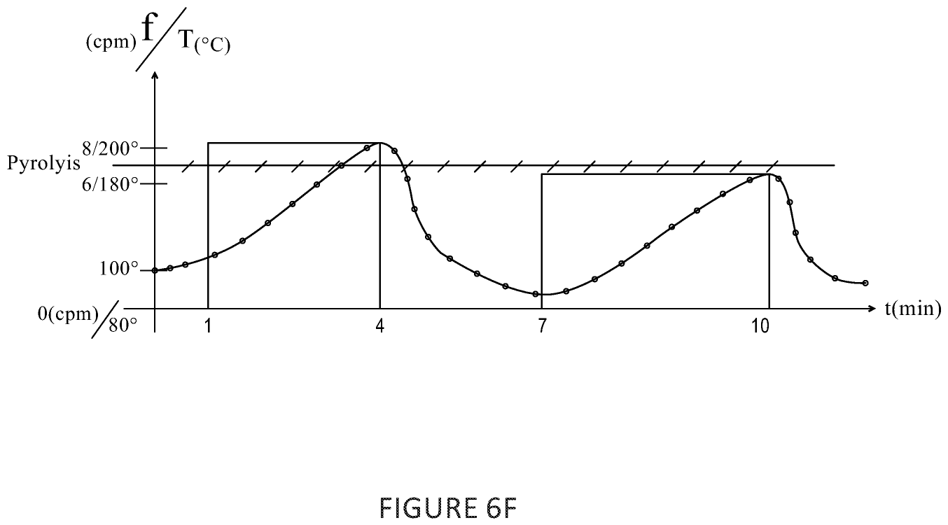

The operation of system 400 will be now further elaborated with respect to simplified systems which exemplify particular options of system 400. Reference is now also made to FIGS. 6A-6E and 7-10B. FIGS. 6A-6E are schematic charts of several heating patterns as a function of time, of a matter heated in conjunction with the system of FIG. 5. FIGS. 7-10B illustrate variations of a fume dissolution and accumulation system constructed and operative in accordance with the invention which includes a sonic fume-dissolution harvester according to FIG. 1, 2 or 3.

In reference to FIG. 7, there is shown a closed-loop system constructed and operative in accordance with the invention, denoted 500, featuring ultrasound transmitters 428 disposed in solvent pool 418 wherein the solvent-fume mixture gushing out from sonic fume-dissolution harvester 402 is drawn by pump 423 to the bottom of solvent pool 418 for a slowed down rise of the bubbles through a series of perforated plates 476 for prolonging exposure to the ultrasound energy of transmitters 428. In addition, the dry gas emitted from receptacle 416 (after separation from the solvent) is recirculated via piping 448 (featuring pump 454) to the bottom of fume generating compartment 404 wherein matter 406 is heated as in a furnace, e.g., by electric heating elements 405 (with or without burning matter 478).

FIG. 8 illustrates a closed-loop system constructed and operative in accordance with the invention, denoted 600, featuring a heating chamber in which the matter to be vaporized is placed, while a separate stove heats recirculated dry gas. System 600 is similar to system 500 of FIG. 7, and features a heating chamber 403 in which the matter 406 to be vaporized is placed while fume generating compartment 404 merely heats recirculated dry gas emitted (and conducted via piping 448 featuring pump 454) from receptacle 416 (e.g., by electric heating, such as by means 405, for which oxygen enrichment is redundant), and control valve 482 which selectively allows the emitted fume gush to access sonic fume-dissolution harvester 402, and/or air pump 484 can control an intermittent flow for eliminating pyrolysis as explained below.

In reference to FIG. 9, there is shown a closed-loop system constructed and operative in accordance with the invention, denoted 700, in which burning is taking place in an oven with oxygen enrichment. System 700 is similar to system 500 of FIG. 7, in which burning of matter 406 is taking place in fume generating compartment 404, and in addition to recirculated dry gases emitted (and conducted via piping 448 featuring pump 454) from receptacle 416, air or oxygen also enters fume generating compartment 404 for oxygen enrichment for the burning process, wherein control valve 482 which selectively allows the emitted fume gush to access sonic fume-dissolution harvester 402, and/or dry gas pump 454 and/or air pump 408 can control an intermittent flow for eliminating pyrolysis as explained below.

In reference to FIG. 10A, there is shown a closed-loop system constructed and operative in accordance with the invention, denoted 800, employing a balloon vaporizer. System 800 is similar to system 600 of FIG. 8, featuring heating chamber 403 in which the matter 406 to be vaporized is placed, and employs a balloon vaporizer 486 (e.g., such as Volcano™ Medic2 as is published at https://www.vapormed.com/en/) featuring fan 488 which blows hot air in constant temperature through conic pathway 490 into balloon 492 until balloon 492 is full (reaches a predetermined pressure or filled with a predetermined amount of gas). Alternatively, matter 406 is placed and burned in fume generating compartment 404 featuring a furnace as of system 500 of FIG. 7, and chamber 403 is merely used for accumulating gas and fume. A balloon vaporizer of the prior art exemplifies how heating of tobacco or cannabis is provided by a relatively large device a manner which conforms to natural breathing process for providing the desired profile of compounds of the fume, but requires the user to immediately inhale the smoke released by the large balloon vaporizer—which is not small enough for carrying in a pocket such as the regular vaping devices. The invention herein harnesses this process for capturing vapours with the desired profile of compounds in a solvent or tincture, without requiring the immediate inhalation of human breathing, for harvesting the desired compounds which can be then provided to the human user in a liquid or solid form readily adaptable for emitting by a conventional compact pocket size vaporizer or vaping device, without requiring the carriage of the cumbersome balloon vaporizer.

The gas is then allowed to be released toward sonic fume-dissolution harvester 402 by one-way valve 482 and thereby provides an intermittent flow for eliminating pyrolysis as explained below.

In reference to FIG. 10B, there is shown a closed-loop system constructed and operative in accordance with the invention, denoted 800′, employing a hookah vaporizer 401. System 800′ is similar to system 800 of FIG. 10A with the option of placing matter 406 to be burned in fume generating compartment 404, and as such also resembles the furnace of system 500 of FIG. 7.

Hookah vaporizer 401 is a hookah-type, waterpipe like (narghile) device which is used for capturing fats and fatty components in air and smoke, which are not easily harvested by harvester 402. Hookah vaporizer 401 includes compartment 411 partially filled with fat-solvent liquid 413, air and smoke inlet 415 featuring pipe 417 which is partially immersed in liquid 413, and air and smoke outlet 419 dispose above the surface of liquid 413. Fat solvent liquid 413 can include glycerin, glycerol, or any solvent in which fats tend to easily dissolve. Air and smoke emitted from fume generating compartment 404 is conducted via piping 421 to inlet 415 and pipe 417 into liquid 413 which resides at the bottom compartment 411. Air and smoke in compartment 419 are sucked through outlet 419, and piping 425 into harvester 402. Harvester 402 can feature a suction device such as of devices 102, 202, and 302, alternatively such a similar suction device (or any other suction device) can be disposed between hookah vaporizer 401 and harvester 402, and further alternatively any apparatus configured to force air and smoke to enter compartment 419 from fume generating compartment 404 and to be expelled from compartment 419 toward harvester 402 may be applicable. When suction action is applied, air and smoke withdrawn from compartment 419 induces suction of air and smoke emitted from fume generating compartment 404, which forcible enters into liquid 413 and is released in liquid 413 in a “hubble-bubble” turbulent action typifying waterpipe or hookah apparatus, to thereby enhance dissolution of fatty components which easily dissolve in liquid 413. In addition to the fume harvested and collected in solvent pool 418 (in receptacle 416), the fatty components of the fume are captured, harvested and collected in liquid 413, by the operation of system 800′.

The main components of system 400 of FIG. 5, and systems 500, 600, 700, and 800 of FIGS. 7-10B, are connected and conduct gas, fume and liquid solvent and operates as follows:

Matter to be vaporized or burnt is placed in fume generating compartment 404 (or equivalent components 403 and 404) in which vaporization/combustion/heating means 405 burns and/or vaporizes matter 406 to producing the fume, with optional aerator 408 feeding air to oxygenate combustion if combustion is utilized. The heating may include several disciplines:
(I) A simple, regular heating, is preferably conducted gradually to avoid a ‘thermal shock’ which often has a negative impact of the burnt matter. The heating may reach burning which is often required for retrieving the sought compounds.
(II) Continuous burning which often ends up with pyrolysis—an adverse phenomenon that needs to be avoided for effective smoking.
(III) the burning may be conducted intermittently to imitate the cycle of human inhaling and exhaling cigarette smoke—which is proven to yield the right compounds, as best seen in FIG. 6A: in which the temperature as a function of time is presented as a full curve and the suction as a function of time is controlled in a similar manner but with a curve which is phase-shifted to an earlier (or later) timing for a more effective of the desired burnt matter in suiting its higher presence resulting from the burning process. In a cycle, a controlled gradual rise of temperature period a is followed by a high temperature period b in which burning occurs, which is followed by a controlled gradual drop of temperature period c and finally a stall period d in which the temperature remains low, all periods of which are repeated in the next cycles. For example, THC (of cannabis) undergoes pyrolysis at a temperature of 125 degrees centigrade after 5-10 seconds, and accordingly the high temperature period is controlled to be shorter.
(IV) Another heating discipline avoids pyrolysis by blowing heated air at the required temperature through the matter to be “burned/smoked” (FIGS. 8-9). The blown fume can be controlled by an adequate controller to provide an intermittent stream either by controlling the solvent pump by a controller or by simply implementing a frequency changer (e.g., changes 0 to 50 Hz AC of a triple phase motor) or by a controllable proportional valve (e.g., a conic needle pump which is controlled) that can be controlled to open partially to thereby administer a gradually changing air flow—it is noted that the fatty smoke tends to accumulate and congest needle pumps and therefore frequent cleansing thereof is required, whereas air pumps do not congest. With reference to FIG. 6F in which a graphical chart of air pumping frequency (full line), and heating temperature (dotted line) as a function of time imitating the smoking cycle of a person, is illustrated. A smoking person typically inbreathes at intervals, for a time spanning about 2-4 minutes, 10-20 gulps of about 35-55 cm² in each inhalation, which endures about 1-3 seconds. Controlling the frequency of “inhalations” (e.g., 2.5-10 cycles per minute—CPM)—which is equivalent to controlling the duration of the pauses between inhalations, and controlling the inhalation period (e.g., 1-3 seconds) controls the minimal and maximal temperatures and lead or avoid pyrolysis—the longer the inhalation period and higher the frequency of inhalations the higher the temperature of burning or heating reaches. As the frequency of pumping is changed from zero to 8 CPM from the first to the forth minute the heating temperature gradually rises from 80 degrees centigrade to 250 degrees, crossing the pyrolysis temperature of 190 degrees just before the forth minute, and then as the pump is ceases to operate, the temperature drops rapidly to 100 degrees. Accordingly, if the duration of pumping is ceased just before reaching pyrolysis, or if the frequency is limited for example to 6 CPM as is shown between minutes 7-10 (which is equivalent to prolonging the pauses between each consecutive inhalations), or if the inhalation period is shortened, pyrolysis can be is avoided. In addition, as temperature along the cycle varies gradually, the variety of temperatures leads to a “smoking” process that produces smoke ingredients which are closer to the very ingredients of actual smoking.
(V) Another method for inducing intermittent heating includes employing a balloon vaporizer (FIG. 10A): a fan blows hot air in constant temperature through a conic pathway into a balloon until the balloon is full (reaches a predetermined pressure or filled with a predetermined amount of gas). The gas is then allowed to be inhaled or released by a one-way valve. However, this method is prone to leave residue on the walls of the balloon and the airways and is less efficient for large amounts of smoke.
(VI) Fatty components which easily dissolve in solvents such as glycerine and glycerol can be captured by a preliminary hookah vaporizer disposed upstream of the sonic harvester (FIG. 10B).
(VII) In the case vaporization or heating does not reach burning, pyrolysis does not occur. Heating may be conducted by streaming air heated at a controlled temperature (FIG. 8).
(VIII) Squeezing to crush or crumble the matter to be vaporized before heating/burning enhances derivation of compounds to be vaporized.
(IX) The heating at a particular temperature releases specific compounds which are typically created or emitted at the particular compound-releasing temperature which is intrinsic, immanent or inherent to the compound (herein—“intrinsic temperature”). Sometimes a compound is created (e.g., as a burn product) at a temperature lower (or higher) than the emission or vaporization urging temperature, so the intrinsic temperature includes both values. For some compounds the intrinsic temperature includes more than one particular creation temperature, more than one particular vaporisation/emission temperature, or span along a temperature range. Accordingly, specific compounds may be separately vaporized and collected by separately heating to the respective intrinsic temperatures. The matter to be vaporized is heated initially to the lowest temperature required to yield specific compound(s), which may be collected by the system, and only after exhaustion of their extraction, the system or the collecting components are cleaned or replaced or emptied and the next temperature of is then applied for the next compounds and this may be repeated successively so forth at greater temperatures until all the separately extracted compounds are released as is seen in FIG. 6B in which heating temperature as a function of time is presented, allowing gradual rise. This may lead to continuing extraction of materials that were not exhausted formerly despite the reaching of their releasing temperature. In FIG. 6C, a similar scheme is applied, but the temperature drops to the same “non burning” temperature to. Although only one cycle is shown for each maximal cycle temperature in FIGS. 6B and 6C, there may be several cycles as in FIG. 6A for each particular maximal temperature in a cycle (FIGS. 6D and 6E).

In accordance with further aspects of the invention, there is disclosed a method for fume harvesting by dissolution in a liquid solvent, including the procedure of exerting cavitation in a solvent-fume mix by subjecting the solvent fume mix to the cavitation effect of at least one sonic cavitation device. Exerting cavitation may include streaming the solvent-fume mix through a convergent-divergent neck of the at least one sonic cavitation device, exerting subsonic cavitation wherein the at least one sonic cavitation device includes a subsonic cavitation device, and/or exerting supersonic shockwave in the solvent-fume mix wherein the at least one sonic cavitation device includes a supersonic cavitation device. The method may further include vacuum pumping of the fume by the at least one sonic cavitation device, which may feature a venturi. The streaming may include a smooth or a choke flow through a constricted neck. The supersonic cavitation device may include a de Laval nozzle, and the exerting of supersonic shockwave may include inducing free shock separation by satisfying Summerfield Criterion of P=0.4 . . . 0.35 Pa in an over expanded tube-neck of the de Laval nozzle.

Exerting cavitation can include subjecting of the solvent-fume mix to at least two sonic cavitation devices consecutively arranged in series along a streamline, and such as by subjecting to a subsonic cavitation in an upstream subsonic cavitation device and to a supersonic shockwave in a downstream supersonic cavitation device. Exerting cavitation may include exerting a subsonic or supersonic cavitation and a supersonic shockwave in a single sonic cavitation device whose convergent-divergent neck is operative to exert cavitation effect and a supersonic shockwave.

Exerting cavitation may include exerting ultrasonic cavitation by transmitting ultrasound energy into the solvent-fume mix by an ultrasonic transmitter of the at least one sonic cavitation device, such as by applying ultrasonic energy at frequency range of 0.7-5 MHZ, and at intensity range of 0.3-50 Watt/Cm². Exerting cavitation may include streaming the solvent-fume mix through a convergent-divergent neck of the at least one sonic cavitation device, and wherein exerting ultrasonic cavitation is performed in addition to the streaming by the ultrasonic transmitter which is mounted and operating at, or downstream in the vicinity of, or downstream away from, the neck or the vena contracta of the neck. Exerting ultrasonic cavitation may include releasing the solvent-fume mix at the bottom of a solvent pool to produce gaseous bubbles which rise through the pool and transmitting ultrasound energy by the ultrasonic transmitter disposed in the pool to the of the gaseous bubbles. The releasing may include slowing down the rising of the gaseous bubbles in the pool by a series of horizontal perforated plates disposed in the pool and operational for prolonging exposure of the bubbles to the ultrasound energy, wherein the solvent-fume mix gushes out from another of the at least one sonic cavitation device.

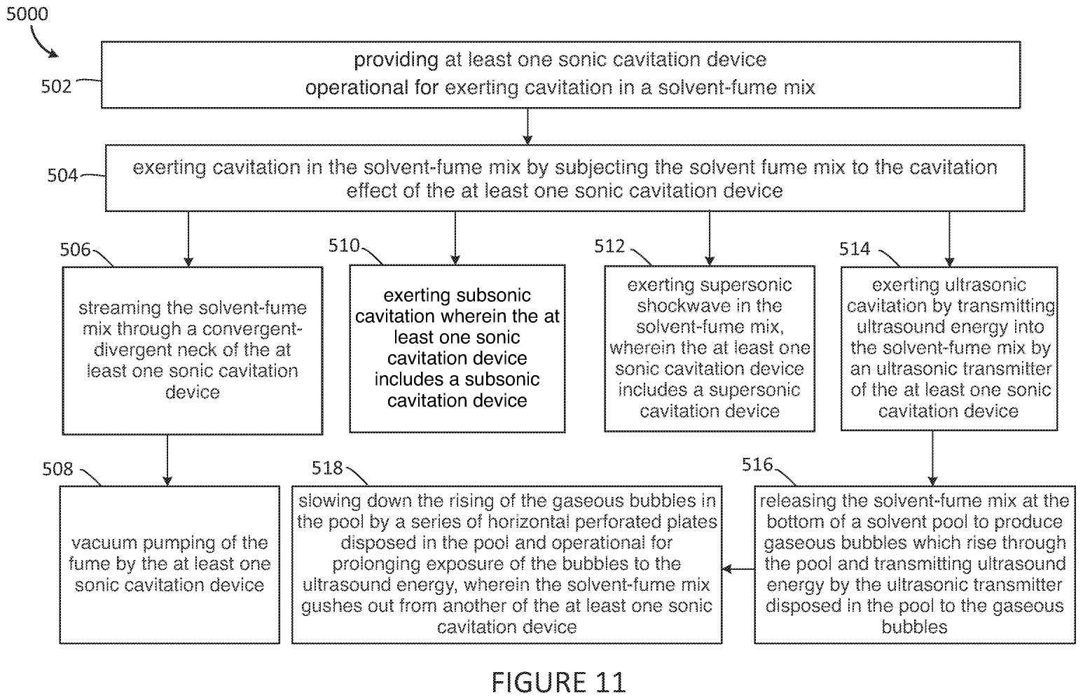

Reference is now made to FIG. 11, in which a block diagram of a fume dissolution method, denoted 5000, operative in accordance with the invention for stimulating and enhancing fume dissolution in a solvent by sub-, super-, and ultra-sonic constrains, is shown. Method 5000 includes procedures 502 to 518. Procedure 502 includes providing at least one sonic cavitation device operational for exerting cavitation in a mixture of liquid-solvent and fume (solvent-fume mix), wherein the fume comprises gas and smoke, vapor, mist or fume-particles suspended in the gas. Procedure 504 includes exerting cavitation in the solvent-fume mix by subjecting the solvent fume mix to the cavitation effect of the at least one sonic cavitation device. With reference to FIG. 1, a solvent-fume mix is streamed through sonic cavitation device 100 which is configured to exert cavitation effect in the solvent-fume mix. Procedure 504 of exerting cavitation can include procedure 506 of streaming the solvent-fume mix through a convergent-divergent neck of the at least one sonic cavitation device. Procedure 506 of streaming can include procedure 508 of vacuum pumping of the fume by the at least one sonic cavitation device. Procedure 506 of streaming may include streaming a smooth flow or a choked-flow through a venturi tube, wherein the at least one sonic cavitation device is a venturi. With reference to FIG. 1, solvent-fume mix 103 is streamed through convergent-divergent neck 110 of sonic cavitation device 102 which features a venturi, wherein the streaming is a smooth flow or a choked-flow, and fume is vacuum pumped by sonic cavitation device 102 with solvent jet 126.

Procedure 504 of exerting cavitation can include procedure 510 of exerting subsonic cavitation wherein the at least one sonic cavitation device includes a subsonic cavitation device. With reference to FIGS. 1, 2, and 3, sonic cavitation device 102, 202, or 302 include a subsonic cavitation device.

Procedure 504 of exerting cavitation can include procedure 512 of exerting supersonic shockwave in the solvent-fume mix, wherein the at least one sonic cavitation device includes a supersonic cavitation device, which may include a de Laval nozzle, which may include inducing free shock separation by satisfying Summerfield Criterion of P=0.4 . . . 0.35 Pa in an over expanded tube-neck of the de Laval nozzle. With reference to FIGS. 1, 2, and 3, supersonic shockwave is exerted in solvent-fume mix 103 in sonic cavitation device 102, 203 or 303, which includes a supersonic cavitation device, which may be a de Laval nozzle that satisfies Summerfield Criterion therefor.

Procedure 504 of exerting cavitation may include subjecting the solvent-fume mix to at least two sonic cavitation devices consecutively arranged in series along a streamline as in procedure 510 and/or procedure 512, or to subsonic cavitation in an upstream subsonic cavitation device as in procedure 510 and to a supersonic shockwave in a downstream supersonic cavitation device as in procedure 512. With reference to FIGS. 2 and 3, two sonic cavitation devices 202 and 203 in FIG. 2, or 302 and 303 in FIG. 3 are consecutively arranged in series along a streamline, wherein device 202 or 302 is an upstream subsonic cavitation device operational to exert subsonic cavitation and device 203 or 303 is a downstream supersonic cavitation device operational to exert supersonic cavitation and a supersonic shockwave.

Procedure 504 of exerting cavitation may include exerting a subsonic or supersonic cavitation as in procedure 510 or 512, and a supersonic shockwave as in procedure 512, in a single sonic cavitation device whose convergent-divergent neck is operative to exert cavitation effect and a supersonic shockwave. With reference to FIG. 1, device 102 is a single sonic cavitation device whose convergent-divergent neck 110 is operative to exert subsonic or supersonic cavitation effect and a supersonic shockwave.

Procedure 504 of exerting cavitation may include procedure 514 of exerting ultrasonic cavitation by transmitting ultrasound energy into the solvent-fume mix by an ultrasonic transmitter of the at least one sonic cavitation device, such as by applying ultrasonic energy at frequency range of 0.7-4 MHZ, and at intensity range of 0.3-50 Watt/Cm². With reference to FIGS. 1, 2, and 3, ultrasonic cavitation is exerted by transmitting ultrasound energy into solvent-fume mix 103 by any of ultrasonic transmitters 114, 118, 214, 218, 214′, 218′, 314, or 318, which may be applied at similar frequency and intensity respective ranges.

Procedure 504 of exerting cavitation can include streaming the solvent-fume mix through a convergent-divergent neck of the at least one sonic cavitation device as in procedure 506, wherein procedure 514 of exerting ultrasonic cavitation is performed in addition to procedure 506 of streaming, by the ultrasonic transmitter which is mounted and operating at, or downstream in the vicinity of, or downstream away from, the neck or the vena contracta of the neck. With reference to FIGS. 1, 2, and 3, solvent-fume mix 130 is streamed through convergent-divergent neck 100, 210, 211, or 350 of sonic cavitation device 102, 202, 203, or 303, respectively, wherein ultrasonic cavitation is exerted in addition to the streaming, by ultrasonic transmitter 114, 118, 214, 218, 214′, 218′, or 318, which is mounted and operating at, or downstream in the vicinity of, or downstream away from, neck 100, 210, 211, or 350 or the vena contracta of neck 100, 210, 211, or 350, respectively.

Procedure 514 of exerting ultrasonic cavitation can include procedure 516 of releasing the solvent-fume mix at the bottom of a solvent pool to produce gaseous bubbles which rise through the pool and transmitting ultrasound energy by the ultrasonic transmitter disposed in the pool to the gaseous bubbles. Procedure 516 of releasing can include procedure 518 of slowing down the rising of the gaseous bubbles in the pool by a series of horizontal perforated plates disposed in the pool and operational for prolonging exposure of the bubbles to the ultrasound energy, wherein the solvent-fume mix gushes out from another of the at least one sonic cavitation device. With reference to FIGS. 5 and 7, solvent-fume mix is released via piping 422 at the bottom of solvent pool 418 to produce gaseous bubbles which rise through pool 418 and ultrasound energy is transmitted to the gaseous bubbles by ultrasonic transmitters 428, which are disposed in pool 418, and the rising of the gaseous bubbles in pool 418 is slowed down by a series of horizontal perforated plates 476 which are disposed in pool 418 and are operational for prolonging exposure of the bubbles to the ultrasound energy, wherein the solvent-fume mix gushes out from sonic cavitation device 402.

According to further aspects of the invention there is provided a method for fume harvesting and accumulation by dissolution of fume in a liquid solvent and accumulating the dissolved fume as a dissolved-fume-extract, or as a fume-extract-concentrate distilled from said dissolved-fume-extract, the method including generating fume in a generating compartment by burning and/or vaporizing fume-releasing source material (matter), wherein the fume includes gas, and smoke, vapor, mist or fume-particles suspended in the gas, wherein the generating may include generating a portion of the fume by exposure of the fume-releasing source material to combustion at burning temperatures, and another portion of the fume by exposure of the fume-releasing source material to evaporation temperatures. Generating fume may include inducing intermittent burning or heating of the matter to avoid pyrolysis by an intermittent fume-generation inducer. The method includes harvesting the fume by at least one fume dissolution harvester operational for dissolving the fume as a solute in a liquid solvent by exerting cavitation in a mixture of liquid-solvent and the fume (“solvent-fume mix”) by subjecting the solvent-fume mix to the cavitation effect of at least one sonic cavitation device. Inducing intermittent burning or heating may include inducing, conducting, or allowing intermittent flow of gas into or from the fume generating compartment by an air pump or an aerator, a balloon vaporizer, and/or a valve, or controlling of the intermittent burning or heating by a controller. Inducing intermittent burning or heating may include repeating the intermittent heating at the intrinsic temperature of at least one specific compound or at successively/progressively rising intrinsic temperatures of respective ones of the at least one specific compound for separately vaporizing the at least one specific compound to allow their respective separate collection. In addition, fatty components can be captured by a preliminary hookah vaporizer disposed upstream of the sonic harvester.

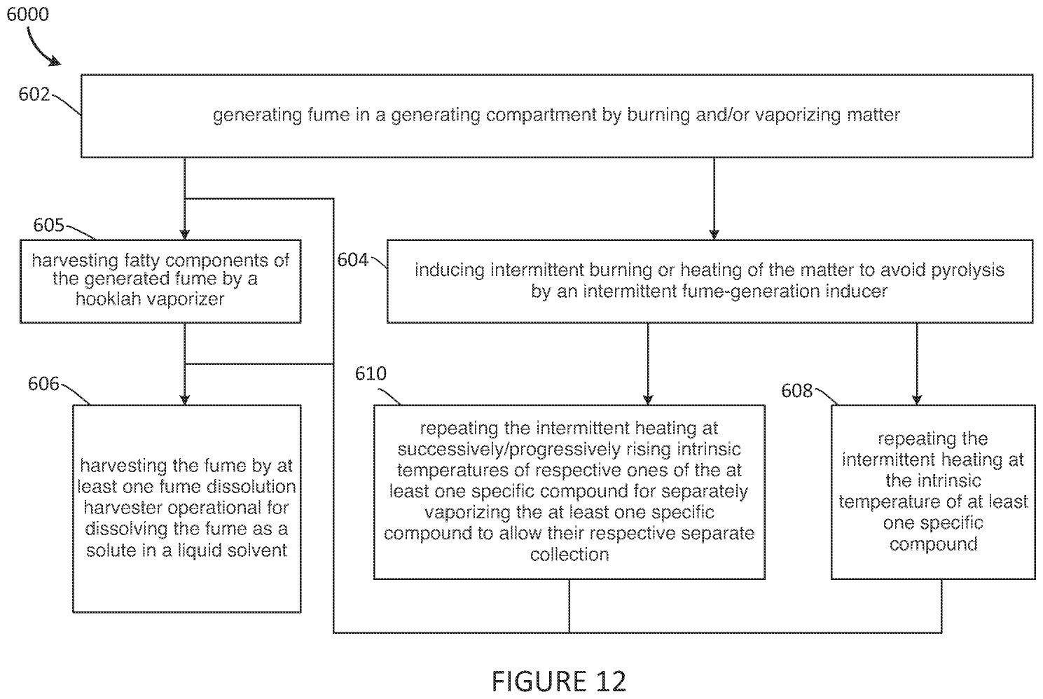

Reference is now made to FIG. 12 which is a block diagram of a fume dissolution and accumulation method, denoted 6000, operative in accordance with the invention for stimulating and enhancing fume dissolution in a solvent by sub-, super-, and ultra-sonic constrains. Method 600 includes procedure 602 of generating fume in a generating compartment by burning and/or vaporizing matter. Procedure 602 of generating may include procedure 604 of inducing intermittent burning or heating of the matter to avoid pyrolysis by an intermittent fume-generation inducer. Method 6000 further includes procedure 606 of harvesting the fume by at least one fume dissolution harvester operational for dissolving the fume as a solute in a liquid solvent, and optional procedure 605 of harvesting fatty components of the generated fume by a preliminary hookla vaporizer, upstream of harvesting the fume by at least one fume dissolution harvester in procedure 606. Procedure 604 of inducing intermittent burning or heating may include inducing, conducting, or allowing intermittent flow of gas into or from the fume generating compartment by an air pump or an aerator, by a balloon vaporizer, and/or by a valve, and may also include controlling the intermittent burning or heating by a controller, e.g., which controls the air pump or the aerator, the balloon vaporizer, and/or the valve. Procedure 604 of inducing intermittent burning or heating can include procedure 608 of repeating the intermittent heating at the intrinsic temperature of at least one specific compound or procedure 610 of repeating the intermittent heating at successively/progressively rising intrinsic temperatures of respective ones of the at least one specific compound for separately vaporizing the at least one specific compound to allow their respective separate collection. With reference to FIGS. 5 and 7, fume is generated in generating compartment 404 by burning and/or vaporizing matter 406, which is harvested by fume dissolution harvester 402 which is operational for dissolving the fume as a solute in a liquid solvent. With reference to FIG. 10B, fatty components of the generated fume are harvested by preliminary hookla vaporizer 401. Intermittent burning or heating of the matter is induced in generating compartment 404 to avoid pyrolysis by an intermittent fume-generation inducer 481, The intermittent heating is repeated in generating compartment 404 at the intrinsic temperature of at least one specific compound or at successively/progressively rising intrinsic temperatures of respective ones of the at least one specific compound for separately vaporizing the at least one specific compound to allow their respective separate collection. Procedures 604 and optional procedures 608 and/or 610 are performed upstream of procedure 606, or of optional procedure 605.

According to further aspects of the invention there is provided a method for fume harvesting and accumulation, including harvesting fume by at least one fume dissolution harvester operational for dissolving the fume as a solute in a liquid solvent, wherein the fume includes gas and smoke, vapor, mist or fume-particles suspended in the gas, and recirculating gas-fume mix under pressure in a closed loop gas circulation, wherein the gas-fume mix is the remainder separated from the liquid solvent downstream of a receptacle for accumulating the fume as a solute dissolved in the solvent, wherein the circulation includes piping and a recirculation blower operational for recirculating the gas-fume mix into at least one of: (1) the at least one fume dissolution harvester; (2) a preliminary fume and solvent mixing chamber disposed upstream of the at least one fume dissolution harvester, and (3) a fume generating compartment.

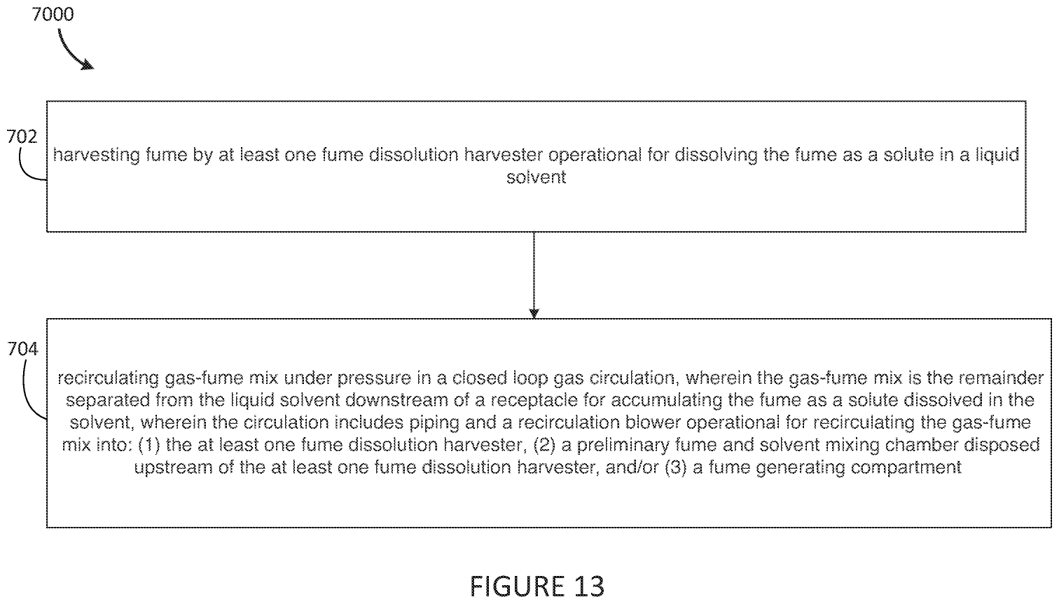

Reference is now made to FIG. 13, which is a block diagram of yet another fume dissolution and accumulation method, denoted 7000, operative in accordance with the invention for stimulating and enhancing fume dissolution in a solvent by sub-, super-, and ultra-sonic constrains. Method 7000 includes procedure 702 of harvesting fume by at least one fume dissolution harvester operational for dissolving the fume as a solute in a liquid solvent. Method 7000 further includes procedure 704 of recirculating gas-fume mix under pressure in a closed loop gas circulation, wherein the gas-fume mix is the remainder separated from the liquid solvent downstream of a receptacle for accumulating the fume as a solute dissolved in the solvent, wherein the circulation includes piping and a recirculation blower operational for recirculating the gas-fume mix into: (1) the at least one fume dissolution harvester, (2) a preliminary fume and solvent mixing chamber disposed upstream of the at least one fume dissolution harvester, and/or (3) a fume generating compartment. Reference also method 6000, wherein procedure 606 or procedure 702 of harvesting fume can include exerting cavitation in a mixture of liquid-solvent and fume by subjecting the mixture to the cavitation effect of at least one sonic cavitation device. With reference to FIG. 5, fume is harvested by fume dissolution harvester 402 which is operational for dissolving the fume as a solute in a liquid solvent, and gas-fume mix is recirculated under pressure in a closed loop gas circulation 446, wherein the gas-fume mix is the remainder separated from the liquid solvent downstream of receptacle 416 for accumulating the fume as a solute dissolved in the solvent (after separation from liquidised solvent and solute by precipitation inducer 430, cyclone separator 438 and solvent condenser 442). Circulation 446 features piping 448, 450, and 452 and a recirculation blower, such as pump 454, which is operational for recirculating the gas-fume mix into fume dissolution harvester 402, or preliminary fume and solvent mixing chamber 414 which is disposed upstream of fume dissolution harvester 402, or fume generating compartment 404. Fume dissolution harvester 402 in FIGS. 5, 7-10 exerts cavitation in a mixture of liquid-solvent and fume by subjecting the mixture to the cavitation effect of a sonic cavitation device.

In some embodiments of the disclosed invention the method for fume harvesting and accumulation includes generating fume in a generating compartment by burning and/or vaporizing matter, providing the generated fume to the at least one fume dissolution harvester, harvesting the fume by at least one fume dissolution harvester by dissolution in a liquid solvent, including the procedure of exerting cavitation in a solvent-fume mix by subjecting the solvent fume mix to the cavitation effect of at least one sonic cavitation device, and any of the following: generating includes inducing burning and/or vaporizing matter with vaporization, combustion, and/or heating means; generating includes oxygenating combustion by aerating with an aerator; providing the generated fume including conveying fresh fume from the fume generating compartment via a fume conveying conduit into the at least one fume dissolution harvester; conveying fresh fume includes drawing fume by a fume blower through the fume conveying conduit; enhancing dissolution of fume in liquid solvent by mixing the fume and the liquid solvent in a preliminary mixing chamber into a solvent-fume mix before entering the at least one fume dissolution harvester; engorging fume particles dissolved in liquid solvent and harvested by the at least one fume dissolution harvester, in a tincture receptacle featuring a tincture pool; supplying solvent from a solvent reservoir to at least one of: (1) the liquid solvent pool; (2) the at least one fume accumulator, and (3) for conduit residue collection and cleansing; conducting the fume-solvent mix from the at least one fume dissolution harvester to the tincture receptacle by piping; cooling heated solvent-fume mix by a solvent-fume cooler disposed downstream of the at least one fume dissolution harvester before streaming into the tincture receptacle; transmitting, by an ultrasound transmitter, ultrasound energy into the solvent-fume mix along piping of the system; releasing said solvent-fume mix at the bottom of a solvent pool to produce gaseous bubbles which rise through said pool and transmitting ultrasound energy by an ultrasonic transmitter disposed in said pool to said of said gaseous bubbles; slowing down the rising of said gaseous bubbles in said pool by a series of horizontal perforated plates disposed in said pool and operational for prolonging exposure of said bubbles to said ultrasound energy, wherein said solvent-fume mix gushes out from another of said at least one sonic cavitation device; separating gas and fume from liquid solvent by a receptacle precipitation separator, upon reaching the receptacle from the at least one fume dissolution harvester, or upon emitting from the solvent pool; for separating cooled gas-fume mix from liquid solvent by a cyclone separator disposed downstream of the fume receptacle; condensing solvent remainder after cyclone separation by a solvent condenser disposed downstream of the cyclone separator; conducting liquidized matter (solvent and solute) to the pool, by eaves conveying liquids for from the receptacle precipitation separator, the cyclone separator, and/or the condenser; solvent circulation for feeding liquid solvent or tincture from the pool or a solvent reservoir to the at least one fume dissolution harvester or the preliminary mixing chamber, including piping and a solvent drawer; washing piping and conduits of the fume dissolution harvester system with the liquid solvent, by an internal conduit residue collection cleansing mechanism operative for releasing fume residue adhered to the sides of the conduits, and for circulating the liquid solvent with the released fume through the conduits to the pool; inducing intermittent burning or heating of the matter to avoid pyrolysis by an intermittent fume-generation inducer; the inducing intermittent burning or heating including inducing, conducting, or allowing intermittent flow of gas into or from the fume generating compartment by an air pump or an aerator, a balloon vaporizer, and/or a valve; the inducing intermittent burning or heating including controlling the intermittent burning or heating by a controller; the inducing intermittent burning or heating including repeating the intermittent heating at the intrinsic temperature of at least one specific compound or at successively/progressively rising intrinsic temperatures of respective ones of the at least one specific compound for separately vaporizing the at least one specific compound to allow their respective separate collection; recirculating gas-fume mix under pressure in a closed loop gas circulation, wherein the gas-fume mix is the remainder separated from the liquid solvent downstream of a receptacle for accumulating the fume as a solute dissolved in the solvent, wherein the circulation includes piping and a recirculation blower operational for recirculating the gas-fume mix into the at least one fume dissolution harvester, a preliminary fume and solvent mixing chamber disposed upstream of the at least one fume dissolution harvester, and/or a fume generating compartment; and controlling, by a controller, operation of system components, and setting and controlling system parameters, including time duration of operation, total weight of matter to be processed, solvent weight before and after the process, pre-set temperature at a fume generator compartment, pressure of liquids, air/gas pressure, vacuum pressure, weight of ash, the degree of turbidity of the solvent for indicating the absorption level of the fume, optical means for qualitative or quantitative measurement of dissolved components, and/or at least one temperature sensor for monitoring and controlling evaporation or combustion heat.

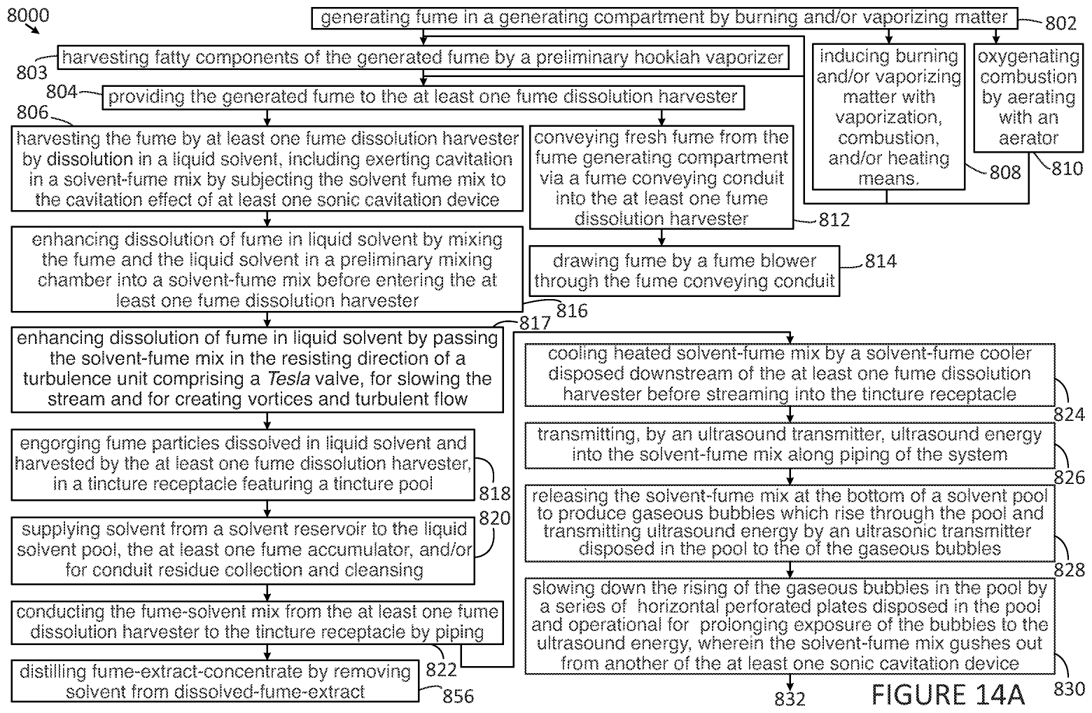

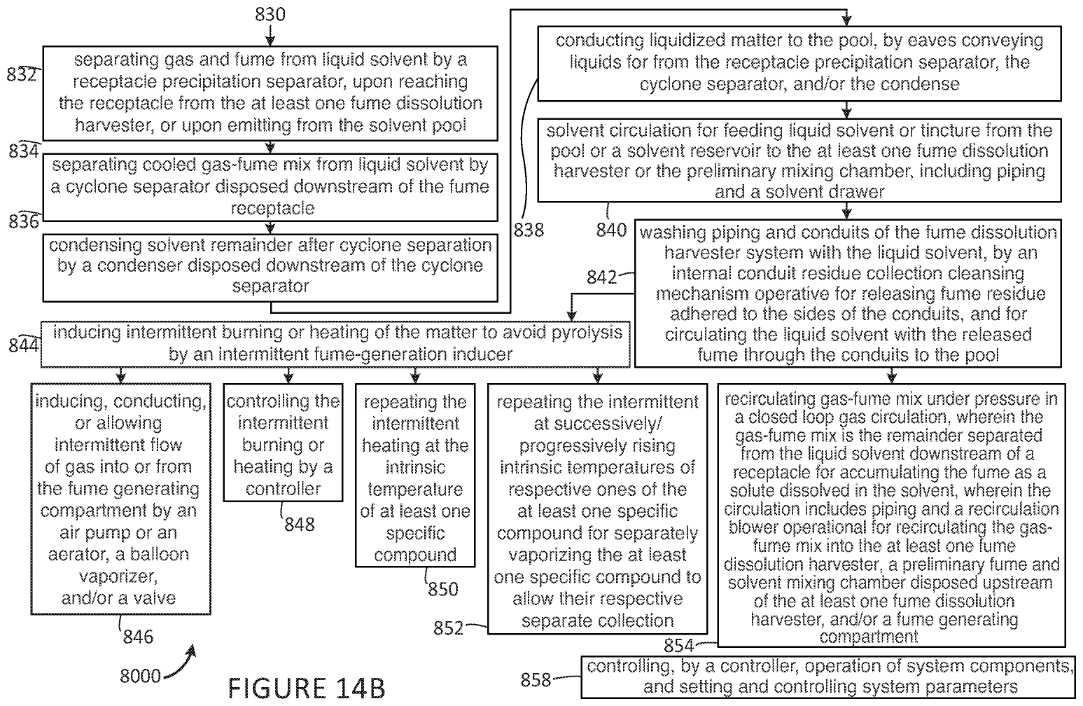

Reference is now made to FIGS. 14A and 14B, which feature a block diagram of a further fume dissolution and accumulation method, denoted 8000, operative in accordance with the invention for stimulating and enhancing fume dissolution in a solvent by sub-, super-, and ultra-sonic constrains. Method 8000 includes the procedures of:
I. Procedure 802 of generating fume in a generating compartment by burning and/or vaporizing matter, wherein the fume includes gas, and smoke, vapor, mist or fume-particles suspended in the gas. With reference to FIG. 5, system 400 includes a fume generating compartment 404 by burning and/or vaporizing matter, wherein the fume includes gas, and smoke, vapor, mist or fume-particles suspended in the gas.
II. Procedure 804 of providing the generated fume to the at least one fume dissolution harvester. With reference to FIG. 5, the generated fume is provided to fume dissolution harvester 402.
III. Procedure 806 of harvesting the fume by at least one fume dissolution harvester by dissolution in a liquid solvent, including the procedure of exerting cavitation in a mixture of liquid-solvent and fume (“solvent-fume mix”) by subjecting the solvent fume mix to the cavitation effect of at least one sonic cavitation device, wherein the fume includes gas and smoke, vapor, mist or fume-particles suspended in the gas. With reference to FIG. 5, sonic cavitation device of fume dissolution harvester 402, and/or any of ultrasonic cavitation devices 426, 428, is operational for exerting cavitation in a mixture of liquid-solvent and fume (solvent-fume mix) by subjecting the solvent fume mix to the cavitation effect of any of these sonic cavitation devices (402, 426, 428, wherein the fume includes gas and smoke, vapor, mist or fume-particles suspended in the gas.
IV. Method 800 may further include at least one procedure of the following:
   (a) Procedure 802 of generating includes procedure 808 of inducing burning and/or vaporizing matter with vaporization, combustion, and/or heating means. With reference to FIG. 5 fume generating compartment 404 includes an oven, stove, or a heating chamber which features vaporization/combustion/heating means 405 for continuously burning and/or vaporizing matter 406. Procedure 810 is performed upstream of procedure 804, or of optional procedure 803.
   (b) Procedure 802 of generating includes procedure 810 of oxygenating combustion by aerating with an aerator. With reference to FIG. 5, fume generating compartment 404 includes an optional aerator 408 for oxygenating combustion. Procedure 810 is performed upstream of procedure 804, or of optional procedure 803.
   (c) Procedure 804 of providing the generated fume includes procedure 812 of conveying fresh fume from the fume generating compartment via a fume conveying conduit into the at least one fume dissolution harvester. With reference to FIG. 5, system 400 includes fume conveying conduit 410 for conveying fresh fume from fume generating compartment 408 into sonic fume-dissolution harvester 402.
   (d) Procedure 803 of harvesting fatty components of the generated fume by a preliminary hookla vaporizer (upstream of harvesting the fume by at least one fume dissolution harvester in procedure 804). With reference to FIG. 10A, fatty components of the generated fume are harvested by preliminary hookla vaporizer 401.
   (e) Procedure 812 of conveying fresh fume comprises procedure 814 of drawing fume by a fume blower through the fume conveying conduit. With reference to FIG. 5, fume conveying conduit 410 features fume blower 412 for drawing fume through fume conveying conduit 410.
   (f) Procedure 816 of enhancing dissolution of fume in liquid solvent by mixing the fume and the liquid solvent in a preliminary mixing chamber into a solvent-fume mix before entering the at least one fume dissolution harvester. With reference to FIG. 5, system 400 includes preliminary mixing chamber 414 for enhancing dissolution of fume in liquid solvent before entering sonic fume-dissolution harvester 402.
   (g) Procedure 817 of enhancing dissolution of fume in liquid solvent by passing the solvent-fume mix in the resisting direction of a turbulence unit comprising a Tesla valve (preferably right before streaming into the tincture receptacle), for slowing the stream and for creating vortices and turbulent flow, to thereby exert pressure on the bubbles for enhancing dissolution. With reference to FIG. 5, system 400 includes a turbulence unit for enhancing dissolution, featuring Tesla valve 427, disposed right before streaming into receptacle 416, for passing the solvent fume mix in the resisting direction, configured for slowing the stream and creating vortices and turbulent flow, to thereby exerting pressure on the bubbles for enhancing dissolution.
   (h) Procedure 818 of engorging fume particles dissolved in liquid solvent and harvested by the at least one fume dissolution harvester, in a tincture receptacle featuring a tincture pool. With reference to FIG. 5, system 400 includes tincture receptacle 416 featuring tincture pool 418 for engorging harvested fume particles dissolved in liquid solvent resting in tincture pool 418.
   (i) Procedure 820 of supplying solvent from a solvent reservoir to the liquid solvent pool, the at least one fume accumulator, and/or for conduit residue collection and cleansing. With reference to FIG. 5, system 400 includes solvent reservoir 420 for supplying solvent to pool 418, sonic fume-dissolution harvester 402, and for optional conduit residue collection cleansing.
   (j) Procedure 822 of conducting the fume-solvent mix from the at least one fume dissolution harvester to the tincture receptacle by piping. With reference to FIG. 5, system 400 includes piping 422 for conducting the fume-solvent mix from sonic fume-dissolution harvester 402 to tincture receptacle 416, which may feature pump 423.
   (k) Procedure 824 of cooling heated solvent-fume mix by a solvent-fume cooler disposed downstream of the at least one fume dissolution harvester before streaming into the tincture receptacle. With reference to FIG. 5, system 400 includes solvent-fume cooler 424 for cooling heated solvent-fume mix downstream of sonic fume-dissolution harvester 402 before streaming into receptacle 416.
   (l) Procedure 826 of transmitting, by an ultrasound transmitter, ultrasound energy into the solvent-fume mix along piping of the system. With reference to FIG. 5, system 400 includes ultrasound transmitters such as transmitters 426 for transmitting ultrasound energy into the solvent-fume mix along the piping of the system, such as downstream of sonic fume-dissolution harvester 402.
   (m) Procedure 828 of releasing the solvent-fume mix at the bottom of a solvent pool to produce gaseous bubbles which rise through the pool and transmitting ultrasound energy by an ultrasonic transmitter disposed in the pool to the of the gaseous bubbles. With reference to FIG. 5, system 400 includes ultrasonic transmitters 428 for transmitting ultrasound energy into the tincture at pool 428 wherein the solvent-fume mix is released at the bottom of pool 428 to produce gaseous bubbles which rise through pool 428 while being exposed to ultrasound energy of ultrasonic transmitters 428.
   (n) Procedure 830 of slowing down the rising of the gaseous bubbles in the pool by a series of horizontal perforated plates disposed in the pool and operational for prolonging exposure of the bubbles to the ultrasound energy, wherein the solvent-fume mix gushes out from another of the at least one sonic cavitation device. With reference to FIG. 5, system 400 includes a series of horizontal perforated plates 476 disposed in pool 428 and operational for slowing down the rising of the gaseous bubbles in pool 428, for prolonging exposure of the bubbles to the ultrasound energy, wherein the solvent-fume mix gushes out from harvester 402.
   (o) Procedure 832 of separating gas and fume from liquid solvent by a receptacle precipitation separator, upon reaching the receptacle from the at least one fume dissolution harvester, or upon emitting from the solvent pool. With reference to FIG. 5, system 400 includes a receptacle separator, such as precipitation separator 430, for separating gas and liquid upon reaching or arriving at receptacle 416 from sonic fume-dissolution harvester 402 or upon emitting from pool 428, such as by showering, sprinkling or drizzling from shower head 432 solvent drops drawn by pump 434 from tincture pool 418 or solvent reservoir 420, and which may feature optional eaves 436 for conducting liquidised solvent and solute to pool 418.
   (p) Procedure 834 of separating cooled gas-fume mix from liquid solvent by a cyclone separator disposed downstream of the fume receptacle. With reference to FIG. 5, system 400 includes cyclone separator 438 for separating between gas-fume mix and solvent evaporating upwards from fume receptacle 416 and are cooled down and whirled therein.
   (q) Procedure 836 of condensing solvent remainder after cyclone separation by a condenser disposed downstream of the cyclone separator. With reference to FIG. 5, system 400 includes solvent condenser 442 for condensing solvent remainder after cyclone separation by further cooling.
   (r) Procedure 838 of conducting liquidized matter (solvent and solute) to the pool, by eaves conveying liquids for from the receptacle precipitation separator, the cyclone separator, and/or the condenser. With reference to FIG. 5, system 400 includes eaves for conducting liquidized matter (solvent and solute) to pool 418, such as eaves 436 from precipitation separator 430, eaves 440 from cyclone separator 438, and eaves 444 from solvent condenser 442.
   (s) Procedure 840 of solvent circulation for feeding liquid solvent or tincture from the pool or a solvent reservoir to the at least one fume dissolution harvester or the preliminary mixing chamber, including piping and a solvent drawer. With reference to FIG. 5, system 400 includes solvent circulation 456 for feeding liquid solvent/tincture from solvent reservoir 420 (via piping 458) or pool 418 (via piping 460) to sonic fume-dissolution harvester 402 (via piping 462) or mixing chamber 414 (via piping 464), featuring a solvent drawer, such as pump 466 or 468.
   (t) Procedure 842 of washing piping and conduits of the fume dissolution harvester system with the liquid solvent, by an internal conduit residue collection cleansing mechanism operative for releasing fume residue adhered to the sides of the conduits, and for circulating the liquid solvent with the released fume through the conduits to the pool. With reference to FIG. 5, system 400 includes an internal conduit residue collection cleansing mechanism, represented by perforated piping 470 and pump 472, operative for washing piping and conduits of fume accumulation system 400 with the liquid solvent for releasing fume residue adhered to the sides of the conduits, and for circulating the liquid solvent with the released fume residue through the conduits.
   (u) Procedure 844 of inducing intermittent burning or heating of the matter to avoid pyrolysis by an intermittent fume-generation inducer. With reference to FIG. 5, system 400 includes intermittent fume-generation inducer 481 for inducing intermittent burning or heating of said matter in fume generating compartment 404 to avoid pyrolysis.
   (v) Procedure 844 of inducing intermittent burning or heating includes procedure 846 of inducing, conducting, or allowing intermittent flow of gas into or from the fume generating compartment by an air pump or an aerator, a balloon vaporizer, and/or a valve. With reference to FIG. 5, system 400 includes air pump or aerator 408; balloon vaporizer 486 (as in FIG. 10A); and valve 482 (FIG. 9) of intermittent fume-generation inducer 481 for inducing, conducting, or allowing intermittent flow of gas into or from fume generating compartment 404.
   (w) Procedure 844 of inducing intermittent burning or heating includes procedure 848 of controlling the intermittent burning or heating by a controller. With reference to FIG. 5, system 400 includes a controller which can be part of intermittent fume-generation inducer 481, or a separate controller operating in collaboration therewith such as controller 474, which is operational to control intermittent burning or heating.
   (x) Procedure 844 of inducing intermittent burning or heating includes procedure 850 of repeating the intermittent heating at the intrinsic temperature of at least one specific compound or procedure 852 of repeating the intermittent at successively/progressively rising intrinsic temperatures of respective ones of the at least one specific compound for separately vaporizing the at least one specific compound to allow their respective separate collection. With reference to FIG. 5, system 400 includes intermittent fume-generation inducer 481 which is configured to repeat the intermittent heating at the intrinsic temperature of at least one specific compound or at successively/progressively rising intrinsic temperatures of respective ones of the at least one specific compounds for separately vaporizing the at least one specific compound to allow their respective separate collection.
   (y) Procedure 854 of recirculating gas-fume mix under pressure in a closed loop gas circulation, wherein the gas-fume mix is the remainder separated from the liquid solvent downstream of a receptacle for accumulating the fume as a solute dissolved in the solvent, wherein the circulation includes piping and a recirculation blower operational for recirculating the gas-fume mix into the at least one fume dissolution harvester, a preliminary fume and solvent mixing chamber disposed upstream of the at least one fume dissolution harvester, and/or a fume generating compartment. With reference to FIG. 5, system 400 includes closed loop gas circulation 446 for recirculating under pressure, into sonic fume-dissolution harvester 402 and/or fume generating compartment 404, gas-fume mix remainder emitted from receptacle 314 (after separation from liquidised solvent and solute by precipitation inducer 430, cyclone separator 438 and solvent condenser 442) featuring piping 448, 450, and 452 and recirculation blower, such as pump 454.
   (z) Procedure 856 of distilling fume-extract-concentrate by removing solvent from dissolved-fume-extract. The distilling may feature evaporating solvent from the dissolved-fume-extract by an evaporator to yield fume-extract-concentrate, such as by a pressure reducing evaporator, a rotary evaporator, or a centrifugal evaporator. With reference to FIG. 5, distillation is carried by solvent remover 483 which may feature an evaporator such as a pressure reducing evaporator, a rotary evaporator, or a centrifugal evaporator, which effectively remove solvent from the dissolved-fume-extract to yield fume-extract-concentrate.
   (aa) Procedure 858 of controlling, by a controller, operation of system components, and setting and controlling system parameters, including at least one of:
      (1) time duration of operation;
      (2) total weight of matter to be processed;
      (3) solvent weight before and after the process;
      (4) pre-set temperature at a fume generator compartment;
      (5) pressure of liquids;
      (6) air/gas pressure;
      (7) vacuum pressure;
      (8) weight of ash;
      (9) the degree of turbidity of the solvent for indicating the absorption level of the fume;
      (10) optical means for qualitative or quantitative measurement of dissolved components;
      (11) at least one temperature sensor for monitoring and controlling evaporation or combustion heat.

With reference to FIG. 5, system 400 includes controller 474 for controlling operation of system components mentioned above, and for setting and controlling the above listed system parameters.

### Example Demonstrating Some Implications of the Invention

In accordance with some aspects of the invention, fume-extract/tincture harvested according to the invention can be used as a substitute of, an ingredient of, or as an additive to: (1) a tincture for consumption comprising said dissolved-fume extract; (2) a tincture for consumption in which said fume-extract-concentrate is blended; (3) consuming material; (4) material for medical purposes; (5) material for cosmetic purposes; (6) material recreational purposes; (7) user-experience additive; (8) fragrance; (9) flavouring; (10) aroma; (11) vaping-material; (12) inhaling-material; (13) smoking-material; (14) drinking-material; (15) eating-material. (16) e-liquid of electronic cigarettes (e-cigarettes); and/or (17) material for topical application. The source-material may include (1) smoking matter; (2) tobacco; and/or (3) cannabis. A portion of the fume-extract-concentrate may be harvested by exposure of the fume releasing source material to combustion at burning temperatures, and another portion of the fume may be harvested by exposure of the material to evaporation temperatures. For consumption in an e-liquid by an e-cigarette, up to 30% of the fume-extract-concentrate may preferably be harvested by exposure of the fume releasing source material to combustion at burning temperatures, wherein the remainder is harvested by exposure of the material to evaporation temperatures. The e-cigarette may be a device combining smoking-material/tobacco/cannabis heating system, such as a combusted or non-combusted heat-stick.

The fume/tincture manufactured according to the invention can contain particularly low levels of Harmful and Potentially Harmful Constituents (HPHCs) found in combusted cigarettes, HPHCs found in smoke and vapor of tobacco or cannabis heating systems, carcinogenic chemicals, genotoxic chemicals, and/or cytotoxic chemicals. The low levels may be below 10% of those found in combusted cigarettes or in smoke and vapor of tobacco or cannabis heating systems. “For smokers who are unable or unwilling to quit using conventional smoking cessation methods such as nicotine replacement therapy (NRT), vaping has a role in tobacco harm reduction. Research suggests that e-cigarettes probably do help people to stop smoking cigarettes” (https://en.wikipedia.org/wiki/Electronic cigarette). However, cigarette smokers who attempt to quit smoking by vaping, often report the vaping as unsatisfactory and revert to smoking cigarettes, despite the 15,000 flavors available on the market. The invention herein was applied to exemplify e-liquid manufacturing.

In an experiment conducted to evaluate the disclosed technique, tobacco was used to extract smoke and fume by a system and a method of the invention described herein. The tobacco was heated to burning temperatures and/or merely heated to evaporation temperatures to prepare e-liquid for an electronic cigarette. It is appreciated that mere evaporation, falling short of burning temperatures, does not produce the harmful toxic constituents which are released by burning, such as in a cigarette and to a lesser amount in a tobacco heat stick). However, evaporation alone does not produce the taste and smell required to produce an experience evaluated by smokers as equivalent or closely comparable to smoking a real conventional cigarette (filtered or not).

To prepare a batch of evaporated-only fume, 200 gr of tobacco which was subjected to evaporation temperatures or a portion of with (without burning) yielded 40 ml of tincture, of which a dosage of 1.6 ml were used by inhalation with propylene glycol or vegetable glycerin, and liquid nicotine (addition of mint flavor liquid is optional). For example, to prepare 102 ml e-liquid, 20 cc of the tincture were inhaled with 35 cc of vegetable glycerin, 25 cc of propylene glycol, 20 cc of nicotine liquid and 2 cc of mint liquid. 8 ml of e-liquid typically fill up the fluid tank of a standard cartridge of a standard electronic cigarette vaping device. Accordingly, about 1 gr of tobacco yielded the tincture for producing 1 cc of e-liquid—enough for 200 inhalations which are deemed equivalent to smoking 20 cigarettes. A standard cartridge or pod is designed as an equivalent of smoking 1-8 standard packs of 20 cigarettes, based on paralleling 20 inhalations of a cigarette smoker to a similar number of inhalations/puffs of a vaping e-cigarette user. In other words, 1 gr of tobacco, which is about the amount of tobacco contained in 1-2 cigarettes (filtered or non-filtered) was used to produce e-liquid equivalent to inhaling a pack of 20 cigarettes.

Accordingly, if vaping the e-liquid produced in accordance of the present invention can be deemed comparable or close to smoking actual cigarettes, it is not only the use of a radically small fraction (˜5%) of the consumed tobacco, it is the dramatical reduction of exposure of the user to the harmful materials which is reduced (˜20 fold) by virtue of the mere reduction of tobacco. The above-mentioned FDA Premarket Tobacco Application (PMTA) presented reduction of about 50% in tobacco consumption of a heat stick in comparison to combustion cigarettes, while the experiment herein reduces about 95% of tobacco consumption.

Exposure to harmful materials is further reduced remarkably by the absence or low concentration of harmful materials extracted according to the present invention in comparison to actual smoking. As evaporation does not produce or hardly produces harmful materials, if the burning temperatures of the combusted portion of tobacco are limited (either kept low or limited to particular ranges, e.g., up to 30% of the total amount, sufficient to release key taste and/or smell inducing constituents), the overall amount of harmful constituents can be strikingly reduced, and for some constituents almost eliminated. Although the example herein is given with respect to tobacco, the implications are valid for all materials (e.g., cannabis) for which the invention is applicable.

Tobacco was taken from four different origins, each collected from the original cigarettes of a very popular brand commercially sold to the general public, so that each batch was prepared from a single origin, i.e., from the very tobacco of a particular brand. From each tobacco origin, several batches were prepared. A “totally-evaporated” batch was prepared from tobacco that was merely evaporated by sequentially exposing the tobacco in the stove at temperatures of 125° C., 155° C., 175° C., 185° C., and 195° C., for intervals gradually rising from 30 minutes for the lowest temperature and 60 minutes for the highest temperature (similar to the operation and method as described with reference to FIGS. 5-6F). A “heavily-burned” batch was prepared by blending 70% of the tincture prepared by the same evaporation process of the first batch and 30% of a tincture prepared from tobacco undergoing burning at temperatures well below pyrolysis by inducing intermittent burning or heating of the matter to avoid pyrolysis by an intermittent fume-generation inducer similar to the operation and method described with reference to FIG. 10A [e.g., 3 seconds fume suction intervals, with fume suction pressure varying in the range of 0.18 bar-4 bar, correlated to solvent supply flow varying in the range of 3-11 LPM (liters per minute) interrupted by a break of 4 seconds]. A ratio of more than about 30% tincture originating from burned tobacco resulted with an excessively smelly product hardly tolerated by most users, but it is this ratio can vary for other users and other batches.

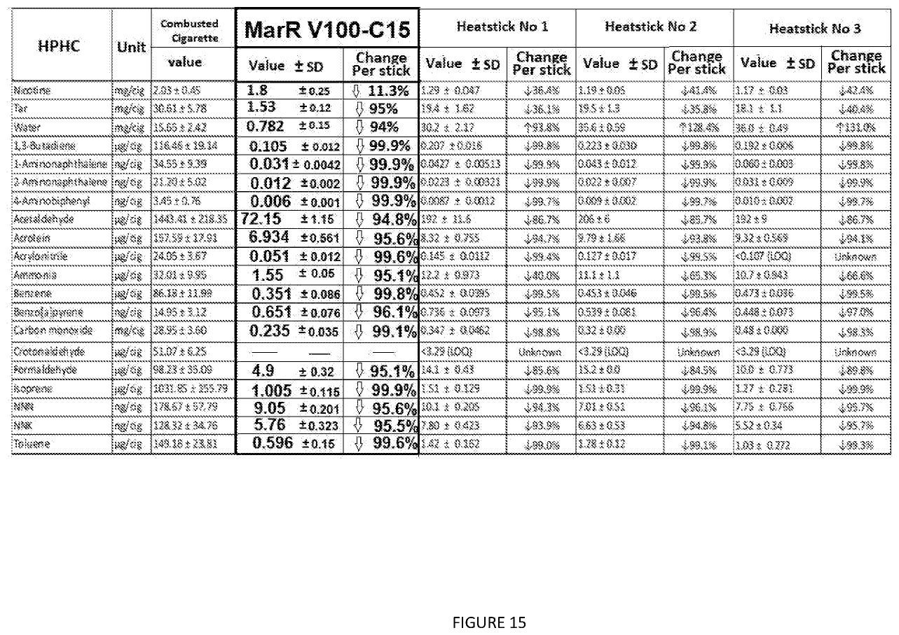

Reference is now made to FIG. 15, which is a table presenting HPHC estimated yields from ‘invention-tincture aerosols’ in comparison to conventional heat-stick aerosols and combusted cigarettes. ‘Invention-tincture aerosols’ are aerosols released from a tincture manufactured in accordance with the invention in the current experiment from an ‘experimental-batch’ comprised of 15% combusted tobacco (at burning temperatures) and 85% evaporated tobacco. The HPHC yields, presented in a column entitled “MarR V100-C15”, are calculated as an estimation based on the amount of tobacco in the e-liquid of the experimental batch (which includes only 5% of the tobacco in a combusted cigarette), when consumed by a heat-stick similar to the conventional heat-stick used to measure heat-stick aerosols and is compared to the constituents released by conventional heat-stick aerosols (Heatstick No 1, Heatstick No 2, Heatstick No 3) and combusted cigarette. The calculated comparison was made to the very data as presented in Table 2: “Comparison of HPHC Yields from Heatstick Aerosols and Combusted Cigarettes”, p. 34 of the above-mentioned FDA Premarket Tobacco Application (PMTA). The amounts and concentration of the listed hazardous constituents in the tincture (e-liquid) manufactured according to the invention, is estimated to be reduced by 94%-99.9% (to levels as low as 6%-0.1%, respectively), except nicotine which was added deliberately, in comparison to combusted cigarettes, well below to the reduction rates of such constituents of the conventional e-liquids in heat-stick aerosols.

Four moderately blended batches of e-liquid (e.g., in the range 0-30% ‘burned’ tincture, and a corresponding 100-70% ‘evaporated’ tincture, such as with a 15%-85% respective ratio) were given to five vaping participant for each batch of each ratio of each cigarette brand tobacco source (ending up with 16 batches of four different brands), who were experienced smokers, all familiar with all of the cigarette brands, some of which were also familiar with tobacco-filled heating-stick aerosol devices (e.g., IQOS®), and all of whom have reported to have attempted to quit smoking by vaping but were frustrated by the unsatisfactory vaping experience (attributed to a taste and smell which they described as remote from experiencing actual smoking). The participants were asked to: (1) identify the cigarette source; (2) rank similarity or closeness (by a percentage value between 0-100%) of their vaping experience in comparison to the actual cigarette smoking experience; (3) express whether they wish to attempt quitting smoking by vaping with the given e-liquid; (4) express whether they would prefer vaping with the given e-liquid heats over smoking with tobacco-filled heat stick device. Irrespective of the particular brand, the results were instructive: (1) ALL participants identified the original brand correctly; (2) after 2-3 minutes, ALL participants ranked their experience in the range of 70%-80% in comparison to smoking the original cigarette; (3) ALL participants expressed their wish to attempt quitting smoking by vaping with the given e-liquid; (4) ALL of those familiar with smoking with tobacco-filled heat stick devices expressed preference of vaping with the given e-liquid over smoking with tobacco-filled heat stick device. 85% of the participants reported they've quitted smoking right after their participation in the experiment and turned to vaping with the e-liquid manufactured pursuant to the invention, and after 3 weeks, 80% reported they've not resumed combustion-cigarette smoking.

It will be appreciated by persons skilled in the art that the technique is not limited to what has been particularly shown and described hereinabove.

In the description and claims of the present application, each of the verbs, “comprise,” “include” and “have,” and conjugates thereof, are used to indicate that the object or objects of the verb are not necessarily a complete listing of components, elements or parts of the subject or subjects of the verb.

Description of embodiments of the invention in the present application are provided by way of example and are not intended to limit the scope of the invention. The described embodiments include different features, not all of which are required in all embodiments of the invention. Some embodiments utilize only some of the features or possible combinations of the features. Variations of embodiments of the invention that are described, and embodiments of the invention including different combinations of features noted in the described embodiments, will occur to persons of the art. The scope of the invention is limited only by the claims.

1. Fume-extract comprising a dissolved-fume-extract accumulated in a solvent (“tincture”) by a fume-dissolution harvesting and accumulation system for accumulating fume in said solvent, or a fume-extract-concentrate distilled from said dissolved-fume-extract, the system comprising at least one fume-dissolution harvester according to claim 51.

2. Fume-dissolution harvesting and accumulation system for accumulating fume in a solvent (“tincture”) for use of a dissolved-fume-extract dissolved and accumulated in said solvent, or a fume-extract-concentrate distilled from said dissolved-fume-extract, the system comprising at least one fume-dissolution harvester according to claim 51.

3. Fume-dissolution harvesting and accumulation system according to claim 2, further comprising a closed loop gas circulation for recirculating under pressure gas-fume mix remainder separated from the liquid solvent downstream of a receptacle for accumulating said fume as a solute dissolved in said solvent (“dissolved-fume-extract”), into at least one of: (1) said at least one fume dissolution harvester; (2); a preliminary fume and solvent mixing chamber disposed upstream of said at least one fume dissolution harvester; and (3) a fume generating compartment.

4. Fume-dissolution harvesting and accumulation system according to claim 59, wherein said fume generating compartment comprises an intermittent fume-generation inducer for inducing intermittent burning or heating of said matter to avoid pyrolysis, by a heating element, heated air streaming, or recirculation of dry gases, which is controlled to intermittently heat the matter in the vicinity of pyrolysis temperature.

5. (canceled)

6. Fume-dissolution harvesting and accumulation system according to claim 4, wherein said intermittent fume-generation inducer is operational to repeat said intermittent heating at the intrinsic temperature of at least one specific compound or at successively/progressively rising intrinsic temperatures of respective ones of said at least one specific compounds for separately vaporizing said at least one specific compound to allow their respective separate collection.

7. (canceled)

8. (canceled)

9. Fume-dissolution harvesting and accumulation system according to claim 2, further comprising a hookla vaporizer for harvesting fatty components of said fume upstream of said at least one fume dissolution harvester.

10. Fume-dissolution harvesting and accumulation system according to claim 2, further comprising an ultrasound transmitter for transmitting ultrasound energy into the solvent-fume mix.

11. (canceled)

12. (canceled)

13. (canceled)

14. (canceled)

15. (canceled)

16. (canceled)

17. (canceled)

18. (canceled)

19. (canceled)

20. (canceled)

21. Fume-dissolution harvester according to claim 51, wherein said at least one sonic cavitation device comprises an hourglass shaped tube, constricted in an intermediate section to form said convergent-divergent neck, the tube comprising:
(a) an upstream inlet lobe into which:
(1) said solvent-fume mix is streamed from a source of fume at an inlet-pressure; and
(2) a jet of fog-sized liquid solvent droplets is sprayed via a spout nozzle;
(b) a downstream outlet lobe in which an outlet-pressure is lower than said inlet-pressure, defining a pressure difference between said inlet lobe and said outlet lobe; and
(c) a constricted intermediate section comprising said neck, wherein said upstream inlet lobe tapers at an entry cone gradience toward said neck and said downstream outlet lobe tapers at an exit cone gradience toward said neck, to thereby induce cavitation effect and/or shockwave at said downstream outlet lobe.

22. (canceled)

23. Fume-extract obtained by a fume-dissolution harvesting and accumulation method for dissolving and accumulating fume in a solvent according to claim 57, wherein the fume extract being a dissolved-fume-extract accumulated in the solvent (“tincture”) or a fume-extract-concentrate distilled from said dissolved-fume-extract.

24. (canceled)

25. (canceled)

26. Fume-extract according to claim 1, wherein up to 30% of said fume-extract-concentrate is harvested by exposure of the fume releasing source-material to combustion at burning temperatures, and the remainder is harvested by exposure of said the fume releasing source material to evaporation temperatures.

27. (canceled)

28. (canceled)

29. (canceled)

30. Method for fume harvesting and accumulation according to claim 57, further comprising the procedure of recirculating gas-fume mix under pressure in a closed loop gas circulation, wherein said gas-fume mix is the remainder separated from the liquid solvent downstream of a receptacle for accumulating said fume as a solute dissolved in said solvent (“dissolved-fume-extract”), wherein said circulation comprises piping and a recirculation blower operational for recirculating said gas-fume mix into at least one of: (1) said at least one fume dissolution harvester; (2) a preliminary fume and solvent mixing chamber disposed upstream of said at least one fume dissolution harvester, and (3) a fume generating compartment.

31. (canceled)

32. (canceled)

33. Method for fume harvesting and accumulation fume according to claim 60, wherein said procedure of inducing intermittent burning or heating comprises repeating said intermittent heating at the intrinsic temperature of at least one specific compound or at successively/progressively rising intrinsic temperatures of respective ones of said at least one specific compound for separately vaporizing said at least one specific compound to allow their respective separate collection.

34. (canceled)

35. (canceled)

36. (canceled)

37. (canceled)

38. Method for fume harvesting and accumulation according to claim 57, further comprising harvesting fatty components of the generated fume by a hookla vaporizer upstream of said at least one fume dissolution harvester.

39. Method for fume harvesting and accumulation according to claim 57, further comprising transmitting, by an ultrasound transmitter, ultrasound energy into the solvent-fume mix.

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. Fume-dissolution harvester for dissolving and harvesting fume in a liquid solvent (“tincture”), comprising at least one sonic cavitation device, wherein the sonic cavitation device is subsonic or supersonic, the device comprising a convergent-divergent neck configured to exert cavitation effect in a mixture of liquid-solvent and fume (“solvent-fume mix”) wherein the solvent-fume mix is applied upstream of the neck and is streamed through the neck, wherein said fume comprises gas, and smoke, vapor, mist or fume-particles suspended in said gas.

52. (canceled)

53. (canceled)

54. (canceled)

55. (canceled)

56. (canceled)

57. Method for fume harvesting by dissolution in a liquid solvent, comprising the procedure of exerting cavitation in a mixture of liquid-solvent and fume (“solvent-fume mix”) by its streaming through at least one sonic cavitation device comprising a subsonic or supersonic cavitation device which comprises a convergent-divergent neck configured to cavitate the solvent-fume mix wherein the solvent-fume mix is applied upstream of the neck and is streamed through the neck, wherein said fume comprises gas and smoke, vapor, mist or fume-particles suspended in said gas.

58. Method for fume harvesting and accumulation, comprising the procedures of:
a. generating fume in a generating compartment by burning and/or vaporizing matter, wherein said fume comprises gas, and smoke, vapor, mist or fume-particles suspended in said gas, wherein said generating comprises inducing intermittent burning or heating of said matter to avoid pyrolysis, by an intermittent fume-generation inducer in which a heating element, heated air streaming, or recirculation of dry gases, is controlled to intermittently heat the matter in the vicinity of pyrolysis temperature; and
b. harvesting said fume by at least one fume dissolution harvester operational for dissolving said fume as a solute in a liquid solvent.

59. Fume-dissolution harvesting and accumulation system according to claim 2, further comprising a fume generating compartment for burning and/or vaporizing fume-releasing source-material (matter) for producing said fume which is provided to said at least one fume-dissolution harvester, wherein said fume generating compartment is configured to produce a portion of said fume by exposure of said fume-releasing source material to combustion at burning temperatures, and another portion of said fume by exposure of said material to evaporation temperatures.

60. Method for fume harvesting according to claim 57, the method comprising generating fume in a generating compartment by burning and/or vaporizing fume-releasing source material, wherein said fume comprises gas, and smoke, vapor, mist or fume-particles suspended in said gas, wherein said generating comprises generating a portion of said fume by exposure of said fume-releasing source material to combustion at burning temperatures, and another portion of said fume by exposure of said fume-releasing source material to evaporation temperatures.

61. Fume-extract according to claim 23, wherein up to 30% of said fume-extract-concentrate is harvested by exposure of the fume releasing source-material to combustion at burning temperatures, and the remainder is harvested by exposure of said the fume releasing source material to evaporation temperatures
